(19) United States
(12) Patent Application Publication
(10) Pub. No.: US 2024/0123459 A1
(43) Pub. Date: Apr. 18, 2024

(54) SPRAY TIP DIAGNOSTICS

(71) Applicant: Wagner Spray Tech Corporation, Plymouth, MN (US)

(72) Inventors: Joseph W. KIEFFER, Chanhassen, MN (US); Lam NGUYEN, Woodbury, MN (US); Jeshwanth Durga Sagar KUNDEM, Minneapolis, MN (US); Xiaogang LUO, Eden Prairie, MN (US); Jan BARTHELMES, Heiligenberg (DE); Nima ABBASPOUR, Salem (DE); Brent M. JANE, Minneapolis, MN (US); Christopher D. NOTO, Carver, MN (US)

(21) Appl. No.: 18/392,415

(22) Filed: Dec. 21, 2023

Related U.S. Application Data
(63) Continuation-in-part of application No. 16/744,778, filed on Jan. 16, 2020.
(60) Provisional application No. 62/874,262, filed on Jul. 15, 2019.
(60) Provisional application No. 62/794,255, filed on Jan. 18, 2019.
(60) Provisional application No. 63/434,597, filed on Dec. 22, 2022.

(51) Int. Cl. B05B 12/00; G05B 23/02

(52) U.S. Cl. CPC B05B 12/004; G05B 23/0283

(57) ABSTRACT

A system includes a fluid spray gun comprising a spray tip having a tip orifice, a pump configured to pump fluid along a flow path to the fluid spray gun, and a monitoring system comprising one or more processors. The monitoring system is configured to obtain data indicative of a flow rate of the fluid along the flow path, obtain data indicative of a pressure of the fluid along the flow path, and determine a tip wear metric indicative of a wear of the spray tip based, at least, on the data indicative of the flow rate of the fluid along the flow path and the data indicative of the pressure of the fluid along the flow path. The monitoring system further controls a display screen to generate a display based on the tip wear metric.

### CROSS-REFERENCE TO RELATED APPLICATIONS

The present application is a continuation-in-part of and claims priority of U.S. patent application Ser. No. 16/744,778, filed on Jan. 16, 2020, which is based on and claims the benefit of U.S. provisional patent application Ser. No. 62/874,262, filed on Jul. 15, 2019, and U.S. provisional patent application Ser. No. 62/794,255, filed on Jan. 18, 2019, the contents of which are hereby incorporated by reference in their entirety. The present application is based on and claims priority of U.S. provisional patent application Ser. No. 63/434,597, filed on Dec. 22, 2022, the contents of which is hereby incorporated by reference in its entirety.

### BACKGROUND

In a fluid spraying system, different fluids (e.g., different types of paints, etc.) have different physical properties that affect atomization rates, and spray patterns. Additionally, different spray tips used by the spraying system have different properties that affect atomization rates, and atomization patterns.

The discussion above is merely provided for general background information and is not intended to be used as an aid in determining the scope of the claimed subject matter. The claimed subject matter is not limited to implementations that solve any or all disadvantages noted in the background.

### SUMMARY

A system includes a fluid spray gun comprising a spray tip having a tip orifice, a pump configured to pump fluid along a flow path to the fluid spray gun, and a monitoring system comprising one or more processors. The monitoring system is configured to obtain data indicative of a flow rate of the fluid along the flow path, obtain data indicative of a pressure of the fluid along the flow path, and determine a tip wear metric indicative of a wear of the spray tip based, at least, on the data indicative of the flow rate of the fluid along the flow path and the data indicative of the pressure of the fluid along the flow path. The monitoring system further controls a display screen to generate a display based on the tip wear metric.

These and various other features and advantages will be apparent from a reading of the following Detailed Description. This Summary and Abstract are not intended to identify key features or essential features of the claimed subject matter, nor are they intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a perspective view showing one example spraying system.

FIG. 2 is a perspective view showing one example fluid applicator.

FIG. 3 is a side view showing one example tip.

FIG. 4 is a perspective view showing one example fluid source.

FIG. 5 is a diagram showing an example interface device.

FIG. 6 is a block diagram showing an example spraying system environment.

FIG. 7 is a flow diagram showing an example operation of a spraying system.

FIGS. 8A-D are side views showing example tips.

FIGS. 9A-B are side views showing example spraying systems.

FIGS. 10A-10K are diagrammatic views showing example user interface displays.

FIGS. 11A-11H are diagrammatic views showing example user interface displays.

FIGS. 12A-12E are diagrammatic views showing example user interface displays.

FIG. 13 is a flow diagram showing an example operation of diagnosing a spray tip.

FIG. 14 is a flow diagram showing an example operation of a spraying system.

FIGS. 15A-15M are diagrammatic views showing example user interface displays.

FIG. 16 shows one example of the architecture illustrated in FIG. 6, deployed in a remote server environment.

FIGS. 17-19 show examples of mobile devices that can be used as operator interface mechanisms in the architectures shown in the previous Figures.

FIG. 20 is a block diagram showing one example of a computing environment that can be used in the architectures shown in the previous Figures.

While the above-identified figures set forth one or more examples of the disclosed subject matter, other examples are also contemplated, as noted in the disclosure. In all cases, this disclosure presents the disclosed subject matter by way of representation and not limitation. It should be understood that numerous other modifications and examples can be devised by those skilled in the art which fall within the scope and spirit of the principles of this disclosure.

### DETAILED DESCRIPTION

Different fluids have different physical properties that affect atomization rates, and atomization patterns. Additionally, different spray tips have different properties that affect atomization rates, and atomization patterns. For the average consumer using a spraying system, determining which conditions are necessary for achieving an even spray pattern (e.g., a spray pattern free of tailing effects) can be difficult. Accordingly, one example spraying system includes features that detect (automatically or with some user input) the current tip and/or the current fluid being sprayed. For instance, the fluid can be identified fully automatically by using a sensor in the fluid and the tip can be identified by automatically reading an RFID tag (or other type of tag) in the tip when the tip is inserted into the applicator or by placing the tip near a sensor associated with the pump. Alternatively, or in addition, the tip can be identified semi-automatically by having the user scan a machine readable (MR) code (such as a barcode, Quick Response (QR) code, image recognition, etc.) on the tip, tip package, etc. and the fluid can be identified semi-automatically by scanning a bar code on a fluid source (e.g., the fluid bucket, etc.). In some examples, the user can use a separate device, such as a mobile device to scan these codes.

Using tip and fluid identification information, the spraying system can be improved to produce desired spraying characteristics. For instance, changing pump settings based on tip size/geometry and fluid characteristics to get desired atomization rates/spray patterns. In some examples, the improvement occurs automatically through automatic adjustment of pump settings. In other examples, the improvement is recommended to the operator, such that they can manually accept or reject the recommended changes.

As a tip wears, or otherwise ages, the characteristics of the tip (e.g., the spray pattern shape/size, flowrate, internal turbulation, etc.) can change. For example, a new tip may dispense twenty ounces per minute (oz/min), while that same tip, after some usage, may dispense twenty-two oz/min. For consistent or otherwise improved spray coverage, examples of the present system accounts for wear affects, for example by adjusting a characteristic of the pump operation. In some examples, the diameter of the tip orifice can be calculated based on the sensed pressure, pump RPM, pump displacement, etc. Additionally, a “life” of the tip can be determined by comparing a current tip's orifice size to the tip's initial orifice size (e.g., 100% tip life) and an unacceptably worn tip orifice size (e.g., 0% tip life).

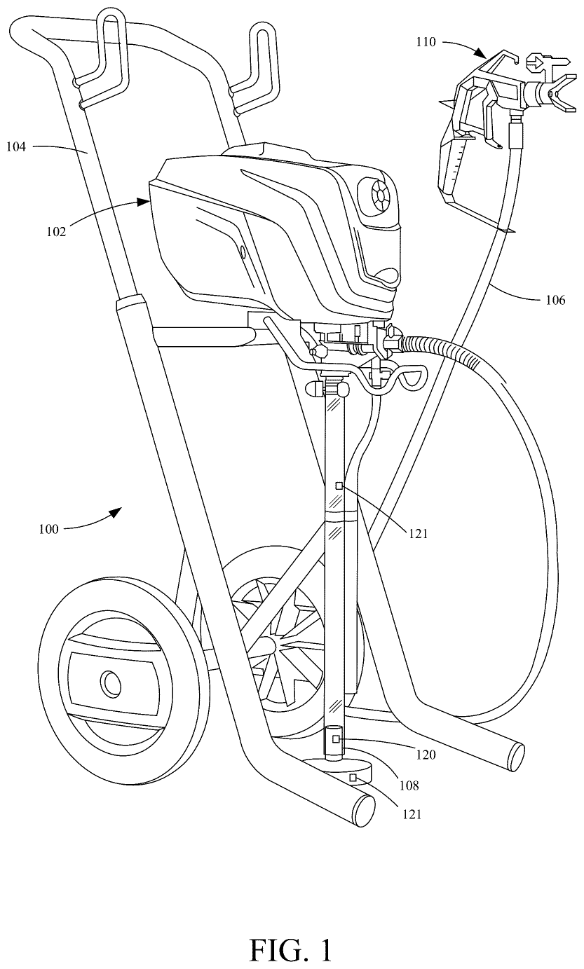

FIG. 1 is a perspective view showing one example spraying system 100. Spraying system 100 includes a pump 102 that is mounted on a cart 104 and couples to an applicator 110 through a delivery line 106. Pump 102 includes a fluid intake 108 that is exposed to a fluid source (e.g., a five-gallon bucket of paint). Pump 102 pumps the fluid from the fluid source through fluid intake 108 and pumps the fluid at a given pressure to applicator 110 through delivery line 106. A fluid sensor 120 can be mounted on fluid intake 108 to sense a type of fluid (e.g., a type of paint). Examples of fluid sensors 120 will be described in greater detail below. Alternatively, or in addition, a fluid level sensor 121 can sense the amount of remaining fluid in the fluid source (via ultrasound, pressure, etc.). When the fluid reaches a threshold level a user can be notified. For example, an alert on a remote/mobile device may notify the user. As another example, a haptic, visual or audible alert on the applicator may notify the user. The fluid level sensor 121 may also track usage over time and notify a user at given intervals. For example, a user may want to be notified when they have three-quarters remaining, one half remaining, one-quarter remaining, etc. This may be useful in helping a user maintain an even coat of fluid coverage over a large spraying job.

In some examples, an electronic device (e.g., smart phone, tablet, PC, etc.) can interface with the pump through a wired or wireless connection. The electronic device can also provide a user interface for a user to control and/or monitor operations of the spraying system 100. For example, setting fluid pressure, entering cleaning mode, tracking fluid throughput, etc. In some examples, water being pumped through spraying system 100 to clean the system is detected and not counted as fluid throughput.

An internet or other network connection of the electronic device can be used to update the software/firmware of the spraying system 100. In other examples, spraying system 100 can directly connect to the internet or another network.

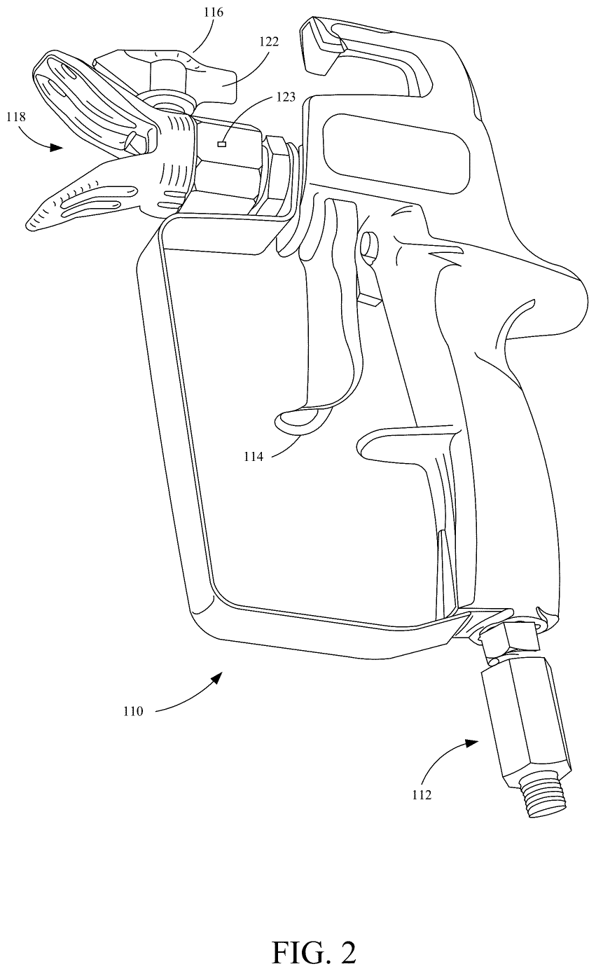

FIG. 2 is a perspective view showing one example fluid applicator 110. Fluid applicator 110 can be similar to the fluid applicator of FIG. 1 or can be a different type of fluid applicator as well. Applicator 110 receives fluid through an inlet 112 (for example from delivery line 106 and then into and through inlet 112). Trigger 114 actuates to allow fluid flow from inlet 112 to an outlet 118 of tip 116 where the fluid is expelled. Often, tip 116 can be replaced with a different type of tip for a different spray pattern or to accommodate a different fluid.

In some cases, tip 116 can include an identifier 122 that is read by a tip sensor 123 coupled to applicator 110. Of course, a different tip sensor 123 could also read identifier 122 as well. Identifier 122 can be a form of RFID tag or similar electronic devices. Tip sensor 123 can be an RFID or other electronic reader that reads the identifier 122 of tip 116 when the objects are within close proximity to each other (e.g., when tip 116 is inserted into applicator 110).

Identifier 122 could be a different type of device, such as a mechanical device. For example, identifier 122 could be a specific profile of tip 116 that contacts a different part of tip sensor 123 based on the type of tip 116 (e.g., each tip would have a unique profile that could be detected by tip sensor 123). Identifier 122 could be a different device as well, such as electronic leads that contact leads (tip sensor 123) on applicator 110. Identifier 122 could include other items as well to transmit identifying information of the tip to tip sensor 123 as well.

As shown, tip sensor 123 wirelessly transmits the tip data to a pump controller. In another example, tip sensor 123 is coupled to a pump controller via a wired connection (e.g., a wire that runs along the length of delivery line 106).

In some examples, an optical sensor can be disposed on fluid applicator 110 (or elsewhere that can sense the fluid being expelled from fluid applicator 110) to sense changes in the spray pattern. For instance, as a tip wears, the pattern it generates can narrow or being to spit. The narrowing or spitting in the pattern can be detected by the optical sensor.

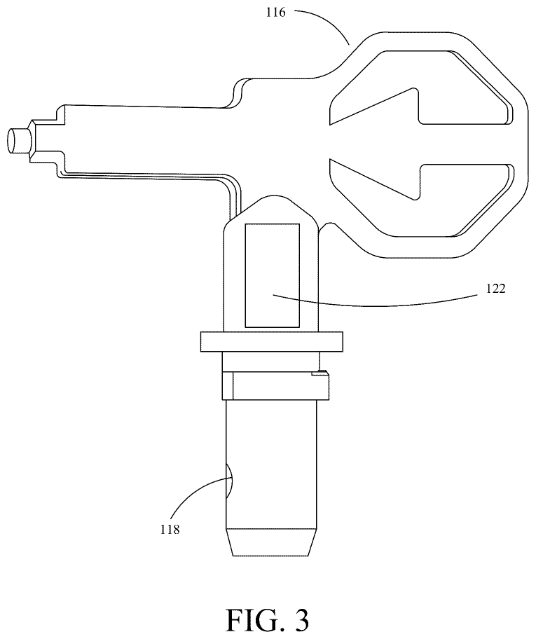

FIG. 3 is a side view showing one example tip 116. Tip 116, as shown, includes an identifier 122 that is an RFID tag. In this case, identifier 122 interacts with tip sensor 123 that is an RFID reader. Tip 116 also has an outlet 118 where paint is expelled from. Each different kind of tip 116 can have a different outlet 118 (and/or internal geometry) that has characteristics that affect the fluid spray expelled from outlet 118. Because each tip 116 may have different spray characteristics, it is important to know which tip 116 is being used to better control the fluid spray from applicator 110. In some examples, tip 116 has keying features to prevent the tip from being inserted into a pump system that is not configured to electronically interact with, or otherwise detect tip 116 (referred to as a “non-smart” pump system). However, in other examples, tip 116 can be inserted into a non-smart pump system and when re-inserted into a smart pump system, the wear from the non-smart pump usage can be estimated, for instance, by calculating the diameter of outlet 118.

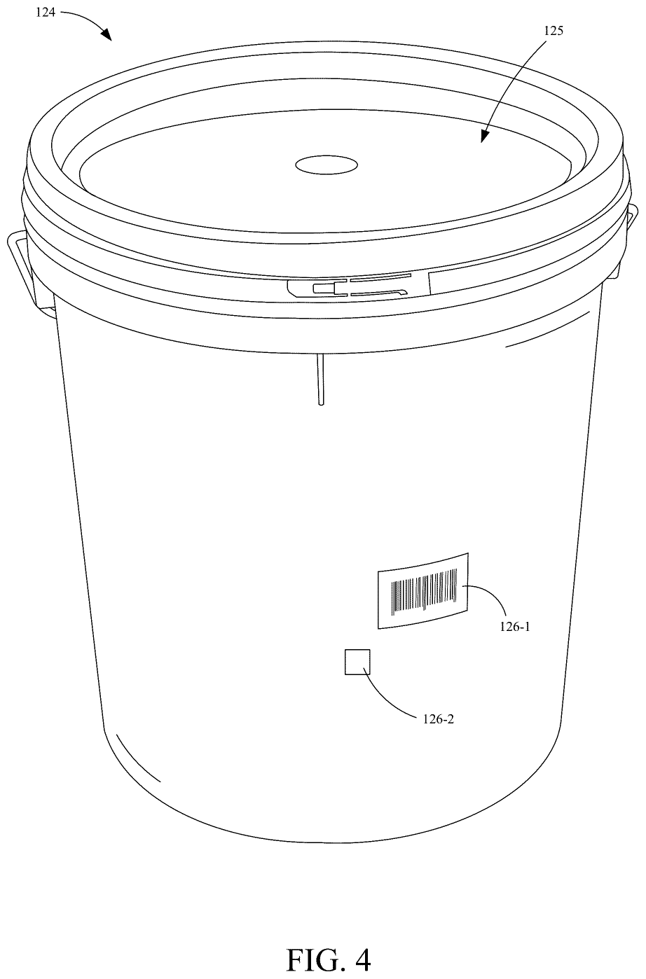

FIG. 4 is a perspective view showing one example fluid source 124. Fluid source 124 has a fluid reservoir 125 and one or more identifiers 126. Identifier 126-1 includes a machine readable code (e.g., a bar code) that is commonly placed on buckets of fluid. In one example, a device can scan identifier 126-1 and identify the fluid within fluid source 124 fluid reservoir 125. Identifier 126-2 includes an RFID tag that is read by an RFID reader (such as fluid sensor 120 located on fluid intake 108 in FIG. 1). Of course, identifiers 126-1 and 126-2 are examples only and other identifiers 126 could be used to identify the fluid as well. For instance, a device can take a picture of fluid source 124 and identify the fluid based on the image (e.g., by identifying brand markings, optical character recognition of the words on the source, etc.).

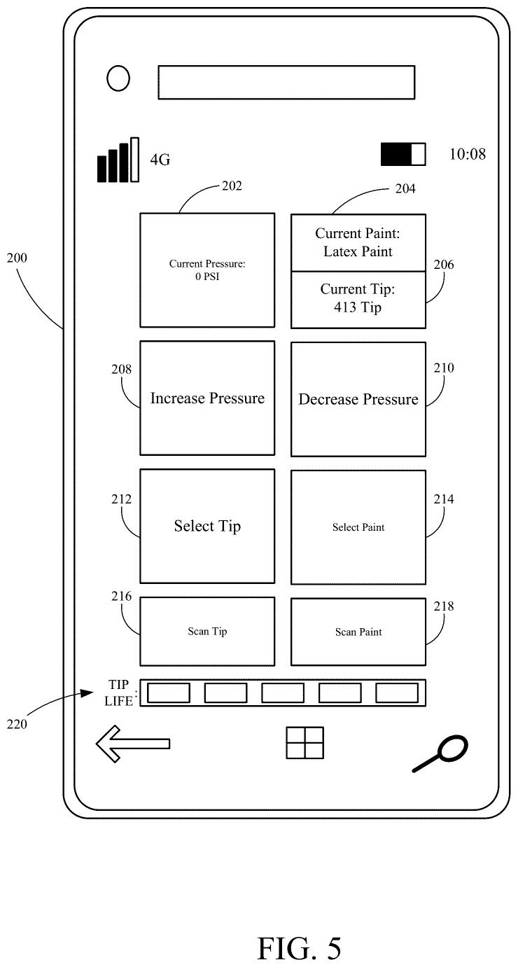

FIG. 5 is a diagram showing an example interface 200. As shown, interface 200 is displayed on a smart phone, however in other examples interface 200 can be displayed on a different device as well. For example, interface 200 could be located on applicator 110, pump 102 a handheld device, a watch, an eye wear, or somewhere else.

Interface 200, as shown, includes pressure indicator 202 that displays a current pressure of the fluid being pumped by the given pump. Fluid indicator 204 is a display mechanism that shows the current fluid being pumped by given pump. Tip indicator 206 is a display mechanism that displays the current tip installed in applicator 110. Pressure increase mechanism 208 is actuatable to increase the current pressure generated by pump 102. Pressure decreased mechanism 210 can be actuated to decrease the current pressure generated by pump 102. In other examples, there may be other actuatable mechanisms that change other settings of pump 102.

Manual tip selection mechanism 212 is actuatable to select a given tip. For example, manual tip selection mechanism 212 is actuated to generate an interface that allows a user to manually select the tip currently installed in applicator 110. Manual fluid selection mechanism 214 is actuatable to select a fluid that is to be applied by applicator 110. For example, manual fluid selection mechanism 214 can be actuated to generate an interface that allows a user to select the current fluid being pumped by pump 102. When the user selects the tip manually, the algorithm (tip life indicator) in the app can also figure out the life of the tip (like wear, flow rate, etc.) based on the pre-defined data set hard coded for each tip. Tip can also mean a nozzle.

Auto tip selection mechanism 216 is actuated to automatically sense the current tip within applicator 110. For example, the tip can be automatically selected by reading the RFID tag within the tip or some other electrical connection between the tip and a device. In another example, the tip can be automatically selected by scanning the barcode on the tip or packaging of the tip, etc.

Automatic fluid selection 218 can be actuated to automatically select the type of fluid being pumped by pump 102. For example, a sensor located in the fluid can sense a type of fluid. In another example, a barcode on the fluid storage device can be scanned to identify the type of fluid. In another example, an RFID or similar electronic mechanism can be read to identify the fluid. In another example, an application uses camera functionality on a mobile device, and the user takes a picture of the name of fluid storage device, and through image recognition the app can figure out the type of fluid.

Tip life indicator 220 displays a current remaining life of the inserted tip. This life can be calculated or estimated by the pump controller. For example, previous data gathered on the wear of certain tips that are spraying certain fluids can be used to estimate wear on the current tip. In some cases, tips can have unique identifiers that identify themselves from other tips (of the same type), this way a tip can be tracked over a given time frame even when being switched with other tips. In one example, a tip used across multiple spraying systems can have its life tracked by saving usage/spray times in combination with the unique tip identifier to a database accessible to multiple spraying systems. In one example, for each tip, the information generated on the wear, shall be saved on to the cloud and is used by the manufacturer to better estimate/understand the tip wear. The manufacturer, who has access to the tip wear data with different coatings, can use the information to better design future tips.

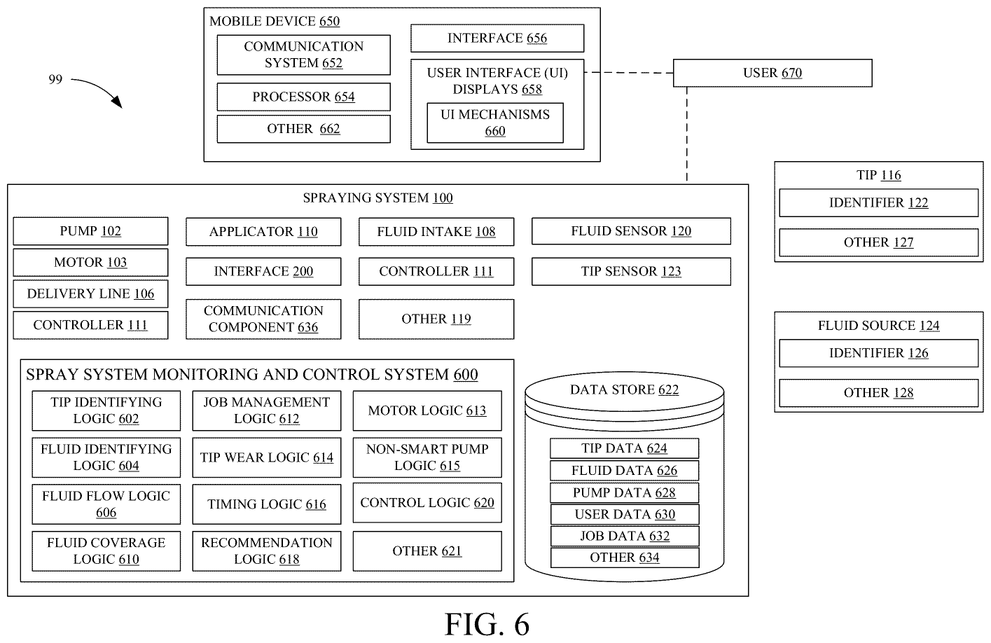

FIG. 6 is a block diagram showing an example spraying system environment 99. For sake of illustration, but not by limitation, environment 99 will be described in the context of system 100 and similar elements are similarly numbered.

Environment 99 includes spraying system 100, tip 116, fluid source 124 and mobile device 650, but can include other items as well. Spraying system 100 includes pump 102 that pumps a fluid from fluid source 124 to applicator 110 and tip 116. System 100 includes a controller 111. In one example, controller 111 comprises a computing device, such as a microprocessor that communicatively couples to pump 102 and sends signals to pump 102 to control various aspects of operation of pump 102. For example, controller 111 monitors pump operation and controls the pump to maintain a fluid pressure in a fluid as it is pumped to applicator 110. In one example, controller 111 includes integrated software or logic components to perform a variety of different functions. For example, integrated software may be used to change the state of a solenoid in a reciprocating piston pump. Controller 111 couples to communication component 636 that allows communication with interface 200, when interface 200 is on another device, such as a smart phone or other mobile device (e.g., interface 656).

As mentioned, controller 111 can include computer processors with associated memory and timing circuitry, not separately shown. They are functional parts of the systems or devices to which they belong and are activated by, and facilitate the functionality of the other components or items in those systems.

Spraying system 100 also includes a data store 622. Data store 622 can store information associated with the pump, tip, spray gun/applicator, users, jobs, etc. For example, as a tip is used, the wear on the tip (e.g., calculated based on throughput of fluid, calculating a tip orifice diameter, etc.) can be stored with the tip identifier in data store 101 as tip data 624. As another example, the pump hours can be stored in data store 622. Data store 622 can reside on spraying system 100 or in another environment, such as a remote server.

Fluid intake 108 facilitates fluid flow from fluid source 124 to pump 102. Delivery line 106 facilitates fluid flow from pump 102 to applicator 110/tip 116. Delivery line 106 can include other items as well, such as, a communication line that facilitates data transfers from any device located on applicator 110 to pump 102. For example, data from applicator 110 can be used to set the pressure generated by pump 102 (e.g., the type of tip in applicator 110).

Interface 200 allows control of pump 102 and ultimately control of the spray pattern generated by the spraying operation. Interface 200 can be located on a housing of pump 102 or can be located remotely as well. For example, interface 200 could be on a mobile device (such as a mobile device 630) that sends control signals to pump 102 wirelessly, or through wired connection. Interface 200 could include different devices and/or mechanisms as well. Spraying system 100 can have one or more tip sensors 123 that identify the type of tip 116 and/or one or more fluid sensors 120 the type of fluid in fluid source 124. Sensors 120 and 123 can include RFID readers, barcode scanners, QR code scanners, fluid sensors, electronic leads/pins and switches, etc. Spraying system 100 can include other items as well, as indicated by block 119. Sensors 120 and 123 can be disposed in a variety of different places, for example, in or on the applicator, a mobile device, a pump, etc.

Spraying system 100 includes spray system monitoring and control system 600. Spray system monitoring and control system 600 includes various software or hardware logic components 602-621. In some examples, these components are implemented by controller 111. In other examples, these components are implemented by a different controller or processor (e.g., processor 654 or another processor located at a remote server).

Spray system monitoring and control system 600 includes tip identifying logic 602 which identifies the tip. For example, tip identifying logic 602 receives sensor signals that indicate the tip model and serial number. In one instance, tip identifying logic 602 receives sensor signals from a camera and identifies the tip based on the image (e.g., by reading a machine-readable code in the image, using optical character recognition to read a serial/model number, etc.). In another instance, tip identifying logic 602 receives sensor signals from a wireless communications sensor and identifies tip 116 based on the wireless signal (e.g., a RFID signal, a Bluetooth signal, an NFC signal, etc.). In another instance, tip identity logic 602 generates interactive components on an interface (e.g., interface 200) that enables a user to manually select a tip. In other examples, tip identifying logic 602 can identify tip 116 in other ways as well.

Fluid identifying logic 604 identifies the fluid. For example, fluid identifying logic 604 receives sensor signals that indicate the type and/or amount of paint. In one instance, fluid identifying logic 604 receives sensor signals from a camera and identifies the fluid by the image (e.g., by reading a machine-readable code in the image such as a barcode, using optical character recognition to read a part number, etc.). In another instance, fluid identifying logic 604 receives sensor signals from a wireless communications sensor and identifies fluid source 124 based on the wireless signal (e.g., a RFID signal, a Bluetooth signal, an NFC signal, etc.). In other examples, fluid identifying logic 604 can identify fluid source 124 in other ways as well.

Fluid flow logic 606 calculates or monitors fluid flow through pump 102. For instance, fluid flow logic 606 can receive sensor signals indicative of displacement of a piston within pump 102 and frequency of the piston reciprocation to calculate fluid flow. In another example, fluid flow logic 606 receives a signal from a fluid flow meter. Fluid flow logic 606 can calculate or monitor fluid flow in other ways as well.

Fluid coverage logic 610 calculates an area and thickness of fluid coverage on a surface being covered by a spraying operation. For example, fluid coverage logic 610 receives sensor signals from motion/location sensors (e.g., inertial measurement unit, gyroscope, accelerometer, proximity sensor, etc.) on an applicator and, a fluid flow rate and a spray pattern area to calculate fluid coverage. For instance, if an applicator 110 moves slower during application the coverage area will be less but the coverage thickness will be greater. Fluid coverage logic 610 can calculate an area and thickness of fluid coverage in other ways as well. Fluid coverage logic 610, in one example, can use visual aids to spatially map the covered paint area, including the ability to calculate the area of curved surfaces. Fluid coverage logic 610, in one example, can use edge detection algorithms, smoothing algorithms, and determines where fluid has or has not been applied, through color detection/light emission schemes.

Job management logic 612 generates user interface displays that a user can interact with to manage jobs. For example, a job can track information about a specific fluid operation at a worksite. Some characteristics of the job include the customer, the users completing the job, the location of the job, the fluid used on the job, the equipment (e.g., pump tip, applicator, etc.) used on the job, the time allocated to complete the job, calculating costs of job, environmental considerations etc. In one example, job management logic 612, can use pre-defined data set for over spray with a tip, to calculate the amount of over spray at the end of day. In one example, the over spray calculation, can help the occupants in deciding the safe duration to return to their space.

Tip wear logic 614 calculates the wear of tips 116 during a spraying operation. For example, tip wear logic 614 can receive information from tip identifying logic 602 as to the characteristics of the current tip 116 (e.g., the tip material, tip diameter tip orifice diameter, tip internal tip geometry, tip pressure ranges, etc.). Tip wear logic 614 can compare the standard characteristics of tip 116 (e.g., the characteristics the tip should have at manufacture) with the current detected characteristics of the tip to calculate a “tip life”. For example, one relevant tip characteristic related to the tip life is the tip orifice size which can be calculated based on the flow rate, pressure, pump characteristics, etc. Comparing the tip at manufacture orifice size to the current tip orifice size and the largest acceptable orifice size can indicate a life of the tip, that is, the length of time a tip has to work effectively. In other examples, tip wear logic 614 calculates tip wear based on the amount of fluid flow that has been through tip 116 and/or the time that tip 116 has been used.

Timing logic 616 calculates and stores the time that the various components of spraying system 100 have been used. For example, pumps need to be serviced after a given amount of time and timing logic 616 keeps track of the time since the pump was last serviced. Similarly, tips need to be replaced often need to be replaced after given amount time and timing logic 616 can automatically keep track of this time.

Recommendation logic 618 generates recommendations for user 670. For example, recommendation logic 618 can receive information from tip identifying logic 602 tip wear logic 614 and fluid identifying logic 604 that indicative of the current tip and fluid being used. With this knowledge, recommendation logic 618 can give a recommendation (e.g., shown to the user on a display of a mobile device or pump) on a pressure to set for effective spraying with the current tip and fluid combination. In another example, recommendation logic 618 receives data from tip wear logic 614 and gives a recommendation to change a setting of pump 102 based on the wear of tip 116 identified by tip wear logic 614. In another example, recommendation logic 618 will give a recommendation to service pump 102 after a time of use has been received from timing logic 616. In one example, the service notifications are also stored in the cloud and the technical service personnel can have access to this information for every pump, before servicing the device. The technical service personnel can look for this information through the pump's serial number in the remote server/cloud and obtain contextual information on the pump which can aide in diagnosing and repairing procedures.

Motor logic 613 interfaces with motor 103 that controls pump 102. For example, motor logic 613 can monitor the motor temperature and send a high temperature alert. As another example, motor logic 613 can monitor the motor RPM, which normally correlates with the fluid flow and/or pressure of the fluid.

Non-smart pump logic 615 includes components to interface with a non-smart pump. For example, non-smart pump logic 615 can connect to a dongle or other device that couples to a non-smart pump to provide some smart pump features. For instance, the run-time, temperature, and revolutions-per-minute (RPMs) of the pump could be monitored by the device and sent to the non-smart pump logic 615. In some cases, non-smart pump logic 615 can receive manual user input on pump usage from a user for the pump.

Control logic 620 generates control signals to control pump 102, motor 103 and other components of spraying system 100. For instance, control logic 620 generates a series of electrical impulses to control motor 103 to operate at a given RPM.

Datastore 622 includes tip data 624, fluid data 626, pump data 628, user data 630, job data 632 and can include other items as well, as indicated by block 634. Tip data 624 can include data on tips, for example, the tip model number, the tip serial number or other identifier, the tip life, the tip usage time, the fluids used with the tip, the tip initial dimensions, the tip current dimensions, etc. Fluid data 626 can include data on fluids, for example, the shear viscosity, extensional viscosity, rheological profile (shear rate graph), density, surface tension, preferred tip for the fluid, etc. Pump data 628 can include data on pumps, for example, the pump horsepower, the pump displacement length, the pump chamber volume, maximum and minimum effective pressure, pump operating history, etc. User data 630 can include data on users, for example, the username, the user run time, fluids used by the user, tips used by the user, pumps used by the user, etc. Job data 632 includes data on jobs, for example, the job location, the job coverage area, the job fluid thickness, the fluid type, the time on the job, the customer associated with the job, etc.

Tip 116 includes identifier 122 that is scanned or otherwise interacts with tip sensor 123 to identify the type of tip 116. Some examples of identifies 122 include serial/mode numbers, electronic ID tags, physical keying features, etc. Tip 116 can include other items as well, as indicated by block 127.

Fluid source 124 includes identifier 126 that can interact with fluid sensor 120 to identify the type of fluid in fluid source 124. Fluid source 124 can include other items as well, as indicated by block 128.

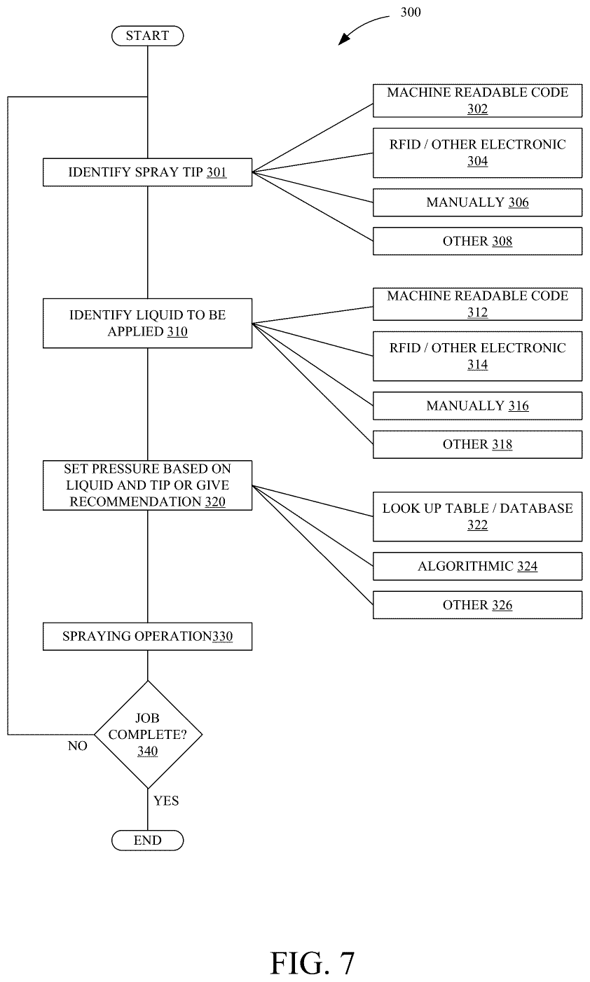

FIG. 7 is a flow diagram showing an example operation of spraying system 100. Operation 300 begins at block 301, where the spray tip is identified (e.g., tip 116 is identified by tip identifying logic 602). Tip 116 can be identified in a variety of different ways, as indicated by blocks 302-308. The spray tip can be identified by scanning a machine-readable code (e.g., a bar or QR code), as indicated by block 302. The bar or QR code can be located on the tip itself, the tip packaging, a tip storage area, etc. The tip can be identified through an RFID, image recognition or other electronic communication, as indicated by block 304. For example, an RFID tag can be embedded in the flag of the spray tip and, when it comes into close proximity of an RFID reader on the applicator 110 or pump 102, the identifying information is read from the RFID tag to identify the tip. The tip can be identified manually, as indicated by block 306. For example, a user selects the tip from a list of tips on an interface (e.g., interface 200). The tip can be identified in other ways as well, as indicated by block 308. For example, an image of the tip can be taken and is analyzed by tip identifying logic 602 to identify the tip.

Operation 300 proceeds at block 310, where the fluid to be applied is identified (e.g., fluid source 124 is identified by fluid identifying logic 604). Fluid can be identified a number of different ways, as indicated by blocks 312-318. Fluid can be identified by scanning a machine-readable code (e.g., a bar or QR code) as indicated by block 312. The machine-readable code can be located on the fluid storage area, the fluid packaging, etc. The reader can be located on a mobile device, the fluid applicator (e.g., applicator 110) or some other device as well.

The fluid to be applied can be identified by an RFID or other electronic method, as indicated by block 314. For example, an RFID tag can be disposed on a bucket in which the fluid is sold in and an RFID reader is located on a fluid intake of the pump to read the RFID tag. The liquid can be identified manually, as indicated by block 316. For example, a user selects the type of fluid from a list on an interface 200. The liquid can be identified in other ways as well, as indicated by block 318. For examples, an image of the fluid source can be taken and is analyzed by fluid identifying logic 604 to identify the fluid source.

Operation 300 proceeds at block 320, where the pressure is set or a recommendation is made, based on the identified fluid and tip (e.g., by recommendation logic 618). The pressure can be retrieved from a lookup table or database of fluids and tips, as indicated by block 322. The pressure can be set based on an algorithm, as indicated by block 324. The pressure can be set based on other items as well, as indicated by block 326. In some examples, a different setting other than pressure is modified.

In addition, or in the alternate, a recommendation may be given to the user. In some examples, the user may be informed of an incompatibility between the fluid and the tip. In some examples, a recommendation may be made to the user to use a different tip/fluid combination for a better spray pattern. In one example, the user selects a desired type of atomization rate or pattern and the system recommends a specific tip/fluid/pump setting combination to achieve the desired outcome.

Operation 300 proceeds at block 330 where the fluid is pumped from the pump 102 to the applicator, where it is sprayed at the pressure determined in block 320. In one example, the pressure or setting is changed automatically (e.g., by control logic 620). In another example, the pressure or setting change is recommended to the user (e.g., by recommendation logic 618 and displayed on a display of the pump, mobile device, etc.). In another example, the pressure or setting change is made automatically, unless the user vetoes the change.

During operation the system 600 can provide other functions as well. For example, the tip life is displayed intermittently during the spray operation to the operator. In another example, as the tip life degrades the pump is adjusted to maintain a consistent spray pattern. Additionally, the flow rate and/or current application thickness are displayed (e.g., in oz/min).

At block 340 it is determined if the job is complete. If so, then operation 300 ends. If not, then operation 300 proceeds to block 301.

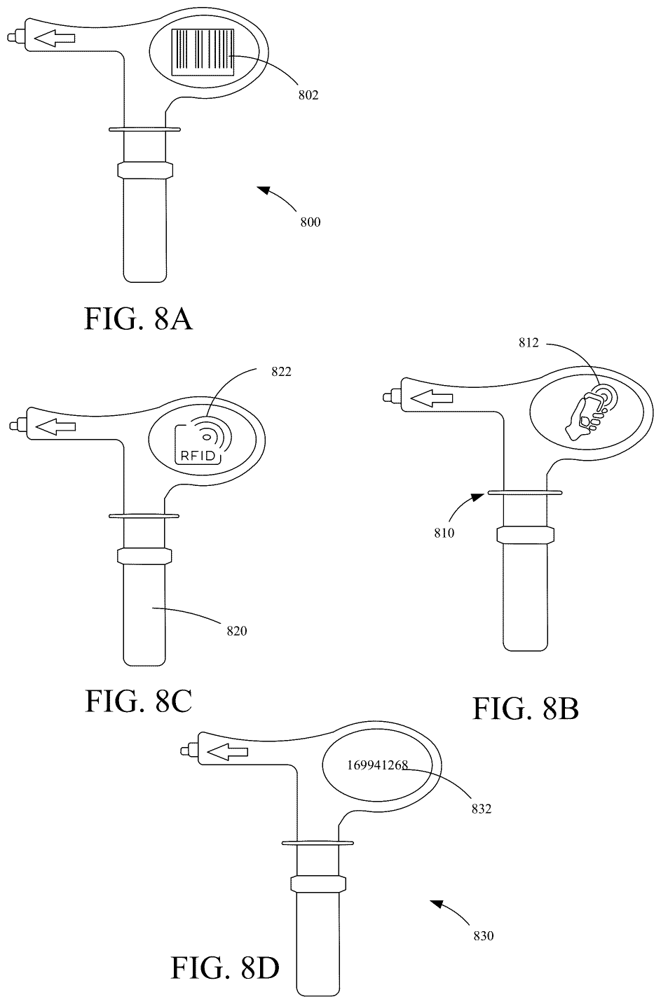

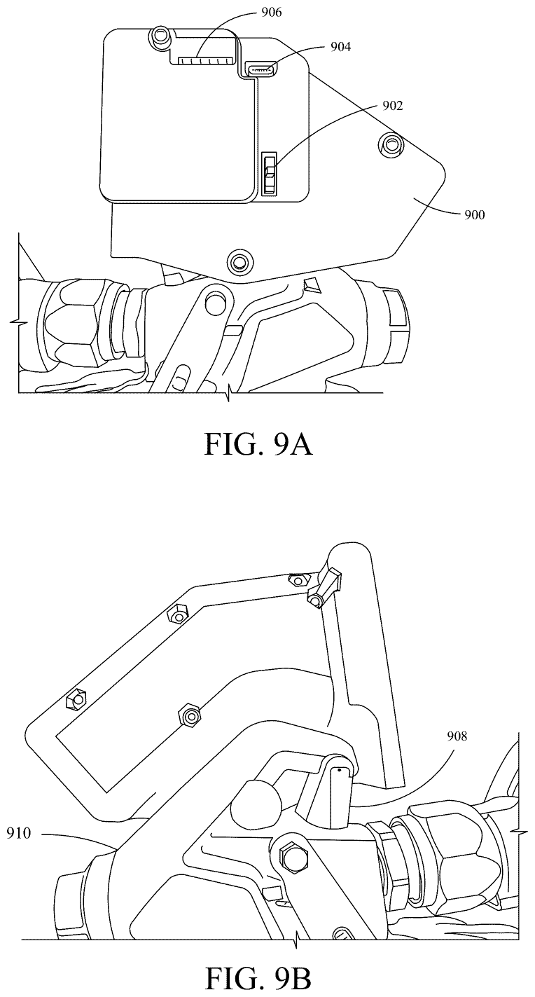

FIG. 8A is a side view showing an example spray tip. The tip of FIG. 8A includes a machine-readable code 802 that can be scanned by a device to identify tip 800. As shown, machine readable code 802 is a barcode, however it could be a different type of machine-readable code as well. One example of an identification device that can read barcode 802 is shown in FIG. 9A-9B.

FIG. 8B is a side view showing an example tip. Tip 810 includes a near field communication device 812. Near field communication device 812 can be sensed by a mobile device or other near field communication device to identify tip 810. One example of an identification device that can communicate with near field communication device 812 is shown in FIGS. 9A-9B.

FIG. 8C is a side view showing an example tip 820. Tip 820 has a RFID identifier 822. RFID identifier 822 can be sensed by another device to identify tip 820. One example of an identification device that can communicate with RFID identifier 822 is shown in FIGS. 9A-9B.

FIG. 9A is a side view of an example identification device 900 that includes a power switch 902, a charger 904, and communication pins 906. Identification device 900 can be any one or more of the devices previously mentioned that identify a tip (e.g., barcode or QR reader, RFID reader, NFC device). Identification device 900 can be powered on or off by switch 902. Identification device 900 can be charged by charging port 904. Identification device 900 can connect to a different device via communication pins 906. In addition, or in the alternate, identification device 900 can wirelessly connect with other components.

FIG. 9B is a side view showing the example identification device 900 of FIG. 9A. As shown, identification device 900 includes coupling device 908 that couples identification device 900 to a fluid applicator 910. As shown, applicator 900 is similar to applicator 110 discussed above. In one example, coupling device 908 requires tools for coupling of identification device 900 to applicator 910. In other examples, coupling device 908 may require no tools to be coupled to applicator 910.

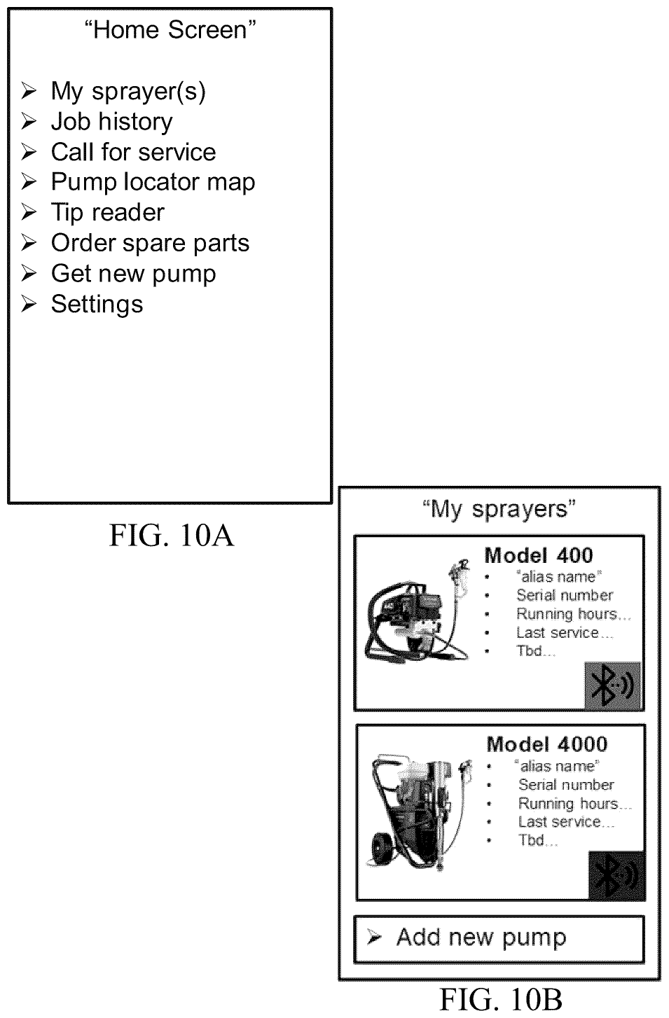

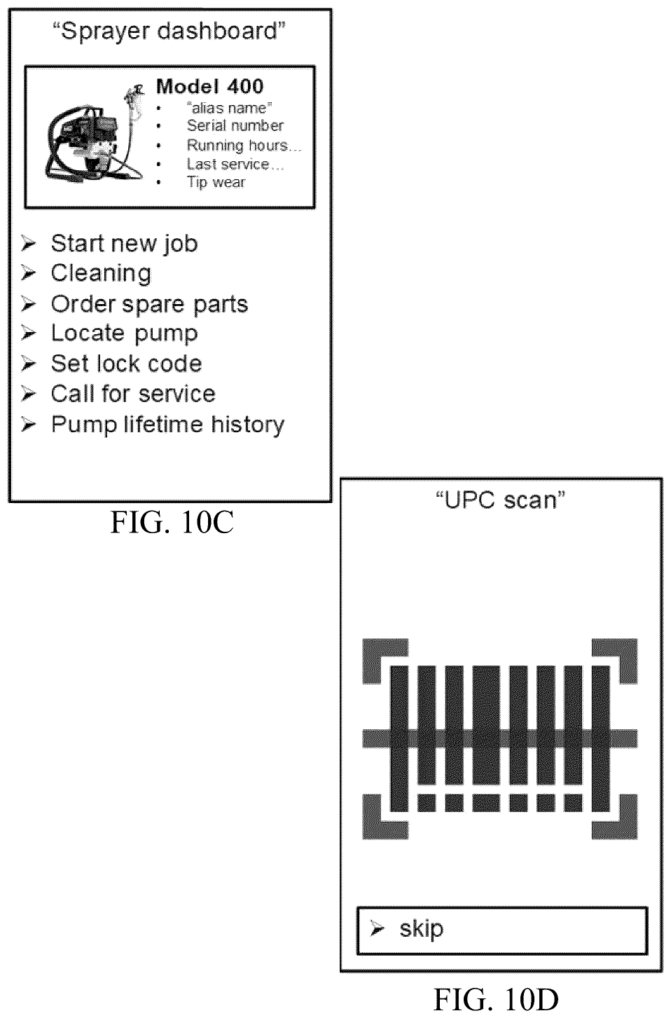

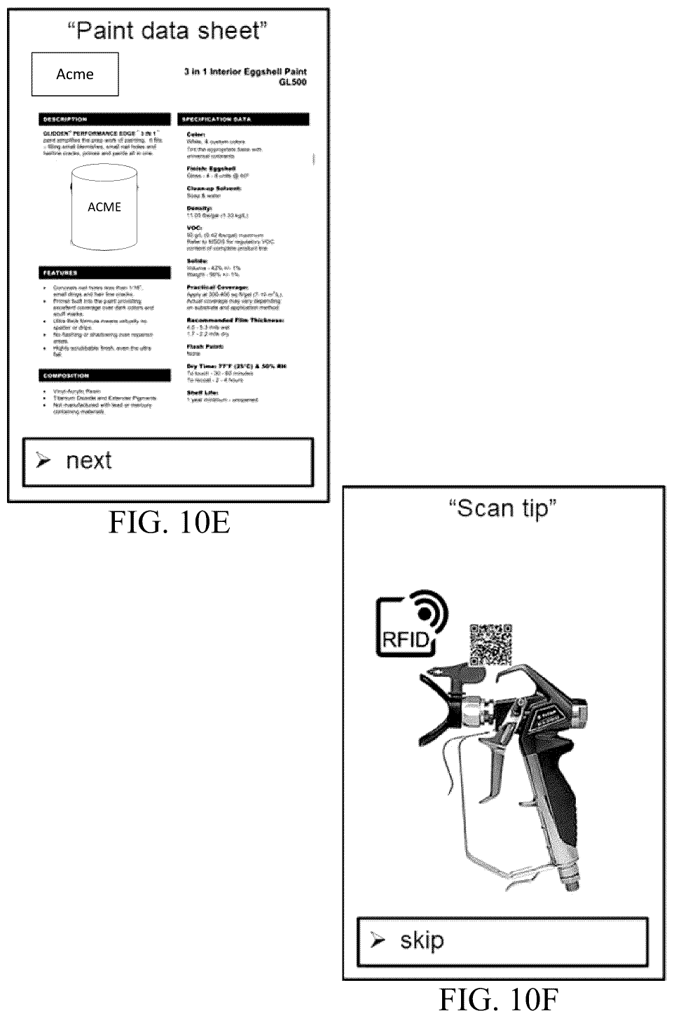

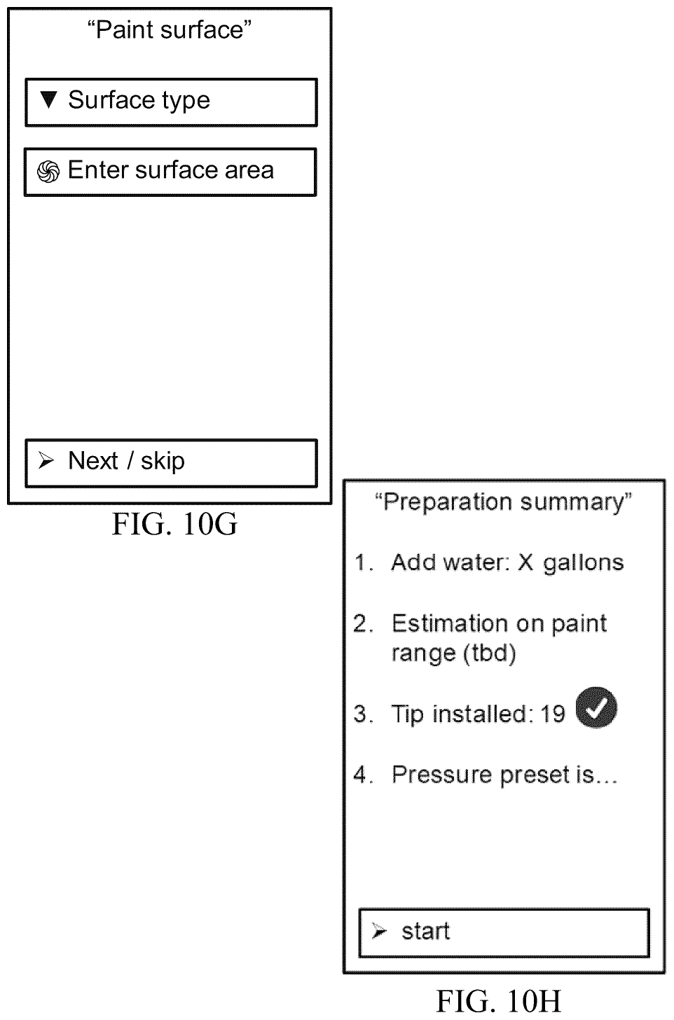

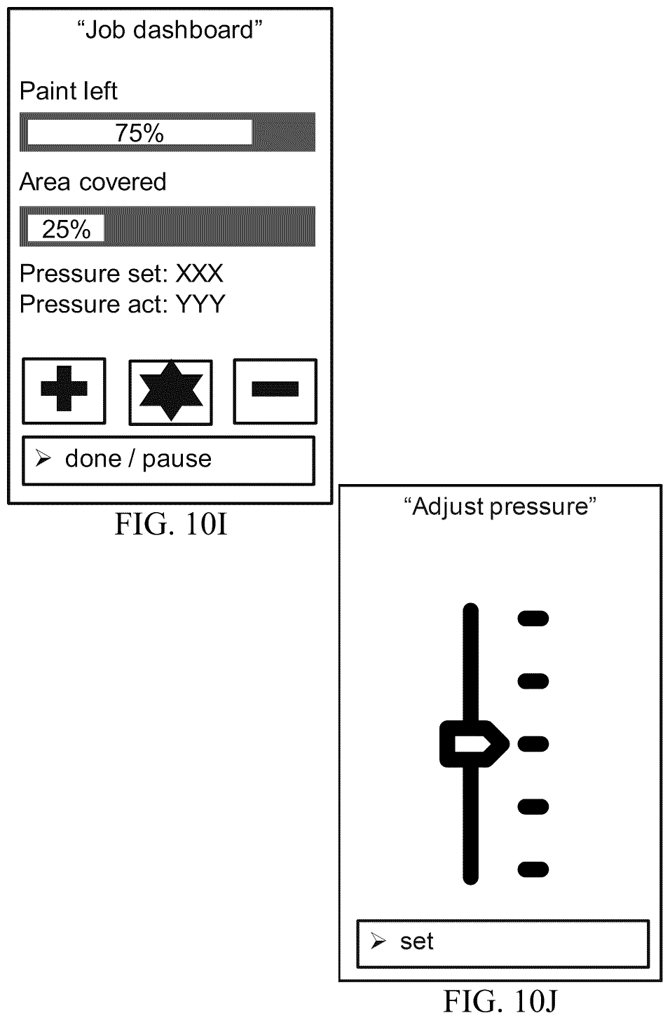

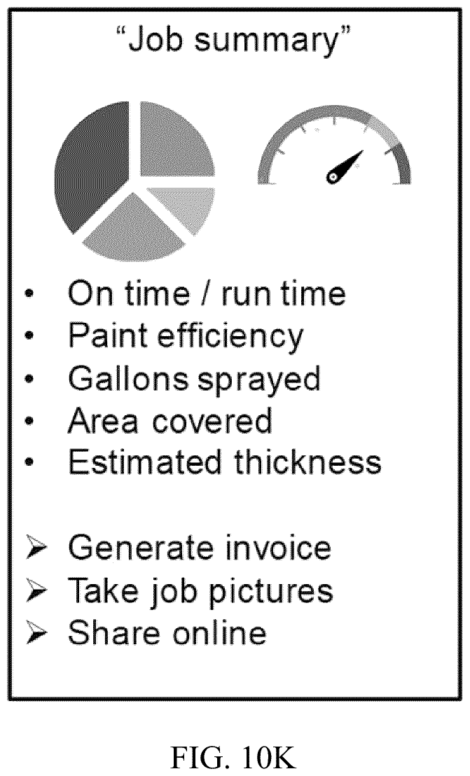

FIGS. 10A-K illustrate example user interfaces that can be displayed on a device (e.g., such as interface 200). FIG. 10A is an example home screen user interface that shows a variety of options, such as, but not limited to my sprayers, job history, call for service, pump locator map, tip reader, order spare parts, get new pump, and settings. Actuating the “my sprayer” mechanism generates the user interface of 10B.

The interface of FIG. 10B shows the sprayers that are currently coupled to the device displaying the interface. For example, as shown, the “model 400 sprayer” is connected to the device (that is displaying the interface) and the model 4000 sprayer is not connected to the device but has been previously connected to or identified by the device. This interface also allows a user to add or remove pumps from the sprayer list for easy connection.

FIG. 10C is an example interface that is shown when a user selects a pump in the interface of FIG. 10B. Interface of FIG. 10C allows a user to perform tasks, such as, start a new job, began auto cleaning of selected pump, order spare pumps for the part, locate the pump (e.g., location of pump can be used based on a strength of a wireless signal), set a lock code for the current pump, called a service, and/or show a pump lifetime history. Of course, these are examples only and more options may be available in the sprayer dashboard interface of FIG. 10C.

FIG. 10D shows an example scanning interface that accesses a camera of the interface device and allows a user to use their camera to locate a UPC, barcode or other MR code.

FIG. 10E is an interface showing fluid data. In the example shown, the fluid is a paint and has been selected by scanning a UPC or barcode on the paint can. For instance, the UPC is scanned and used to acquire fluid information from an online database, in some examples, that could be provided from the fluid manufacturer.

FIG. 10F is similar to FIG. 10D, however, the scanning process is used to identify a tip rather than a fluid. As illustratively shown, the interface of FIG. 10F can allow a user to either scan an MR code (e.g., barcode, QR code, etc.) or can use a wireless connection such as RFID to identify the tip.

FIG. 10G is an example interface that allows a user to enter characteristics of the surface that they will be painting on. For example, a surface type can be chosen such as porous, flat, etc. The surface type can be important in a painting operation as different surfaces absorb paint at different rates or require more paint for proper coverage. The surface area may also be entered. The surface area can be used to calculate the percent complete of a job while a user is spraying. For instance, using the surface type, surface area, and/or desired thickness it can be determined how much paint will need to be used to cover this area. Then this required amount of paint is compared against the paint and operators using during a spraying operation. For instance, it may be calculated that, for proper coverage, 4.5 gallons of paint may be needed and during operation a user can be notified of how much paint they have remaining versus how much paint is required for proper coverage.

FIG. 10H is example an interface that shows a user a preparation summary. A preparation summary can be gathered via the paint information (e.g., the paint information shown in FIG. 10A) and the tip installed amongst other things, such as pump characteristics and/or tip characteristics.

FIG. 10I is an example interface showing a job dashboard. The job dashboard can be displayed while a user is in a spraying operation. Some metrics that can be shown are paint left, area covered, pressure set and pressure acting. Paint left can be calculated via a sensor (e.g., fluid level sensor 121) on the pump. The area covered can be calculated via the previously discussed method of FIG. 10G. For example, an algorithm is used to determine how much paint is needed to paint an area and this is compared against the amount of paint used.

FIG. 10J is an example interface where a user can adjust pressure produced by the pump. As shown, the pressure adjusting mechanism is a slider, however in other examples the pressure adjusting mechanism can be other mechanisms as well. For instance, the pressure can be set with a text input.

FIG. 10K is an example interface showing a job summary. For example, the job summary can tell a user the time that the pump ran, the painting efficiency, the gallons sprayed, the area covered in (e.g., the area covered can be determined based on accelerometers and gyroscopes within the applicator multiplied by the on time of the applicator), estimated thickness, etc. The job summary interface may also allow a user to generate an invoice based on paint usage, on time, etc. Job summary interface may also allow a user to take job pictures of the job that they have completed. Job summary interface can also have a mechanism that allows the user to share their completed job online (such as social media platforms or business websites).

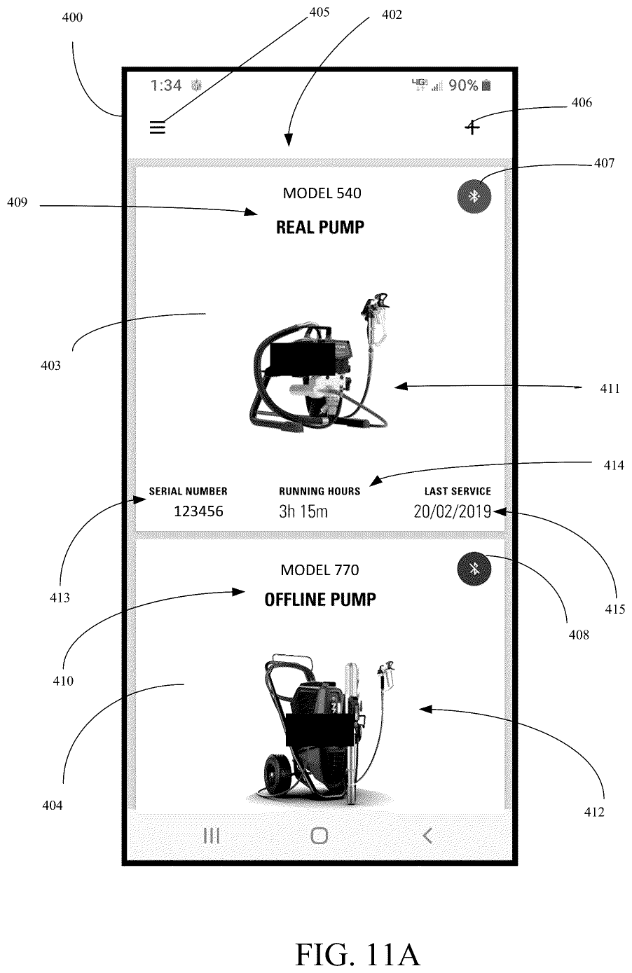

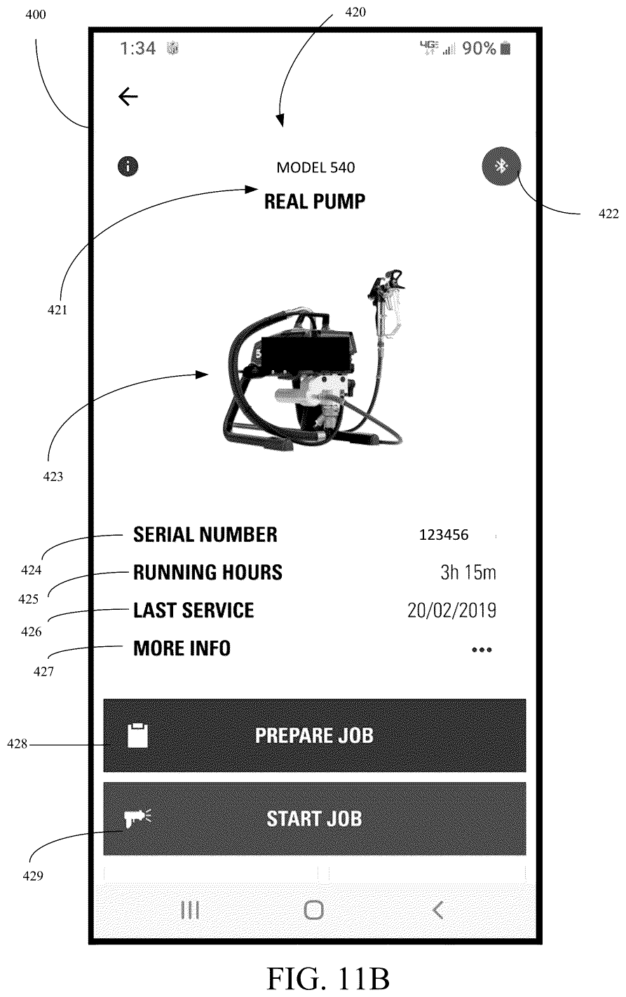

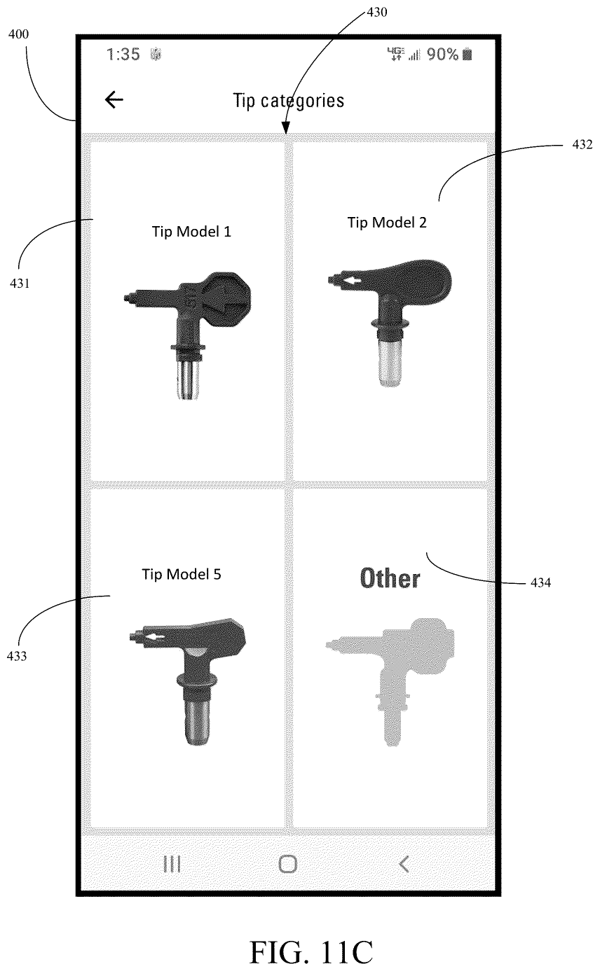

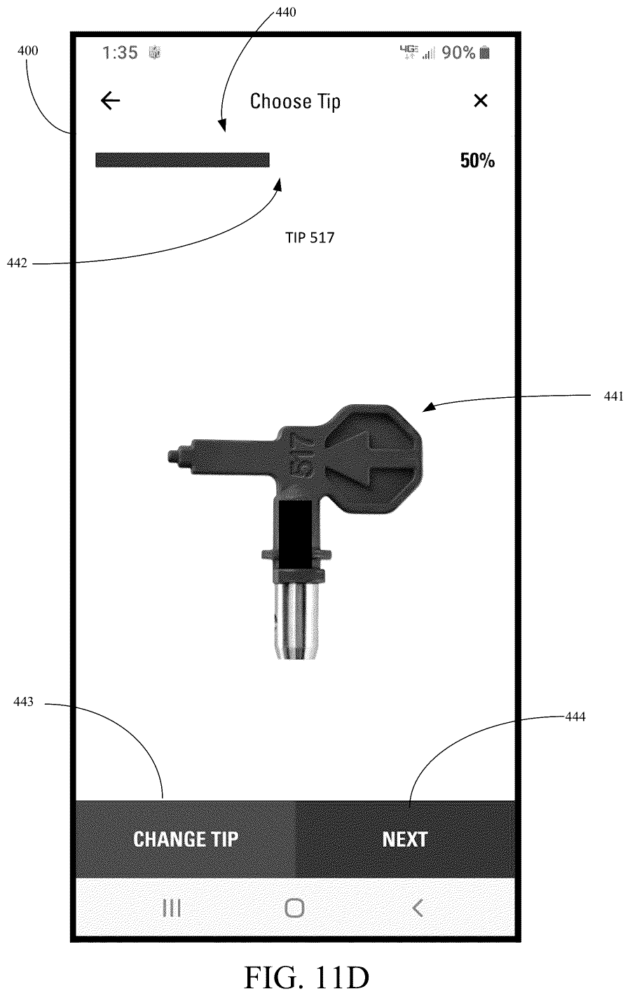

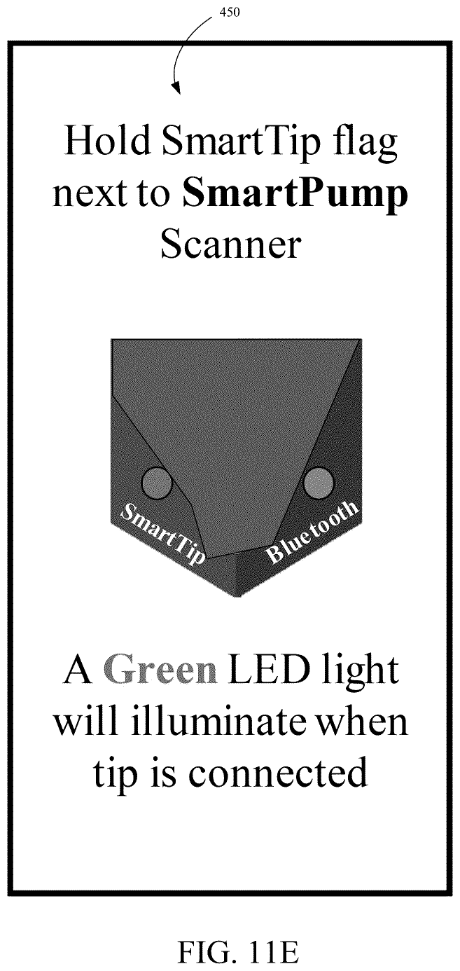

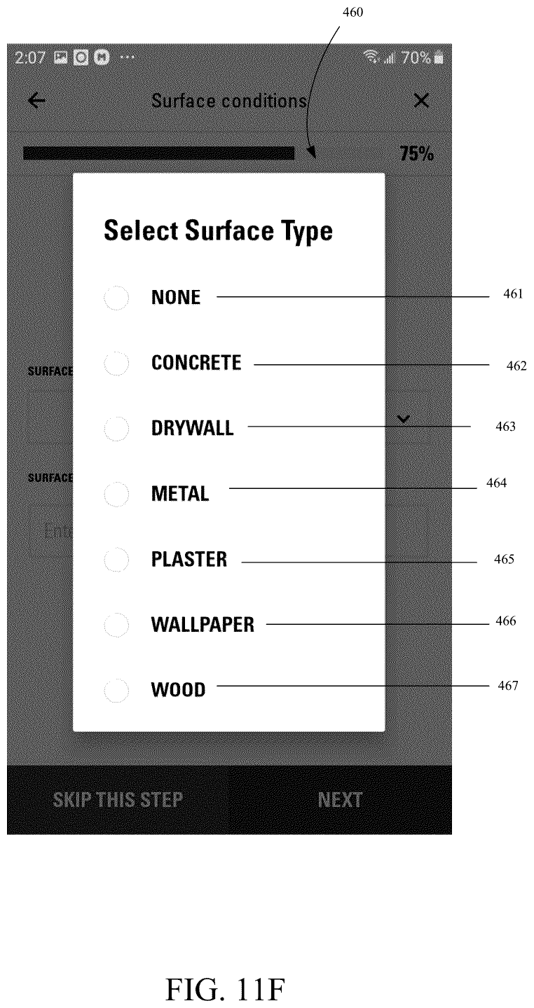

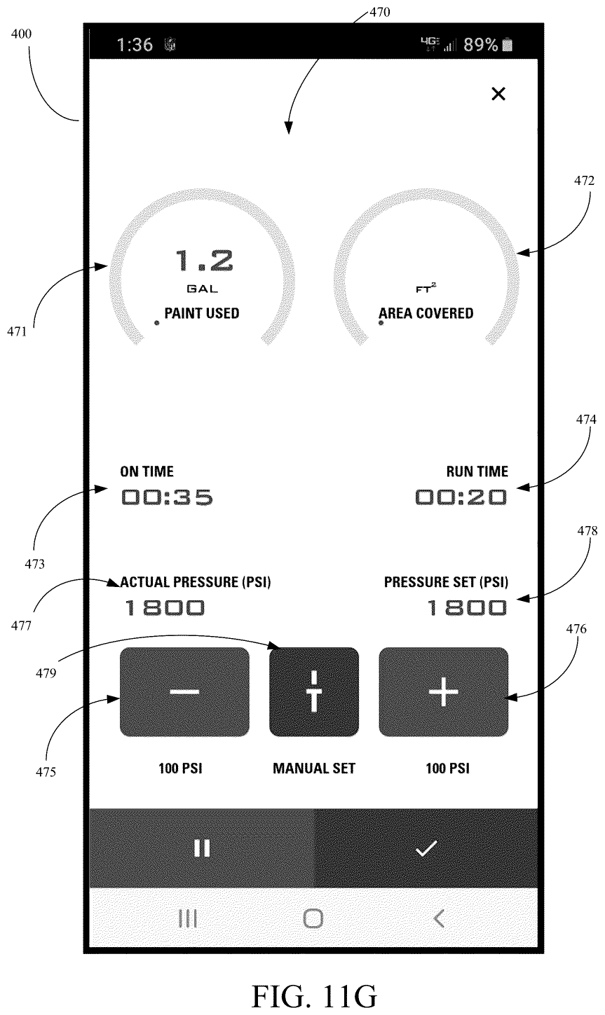

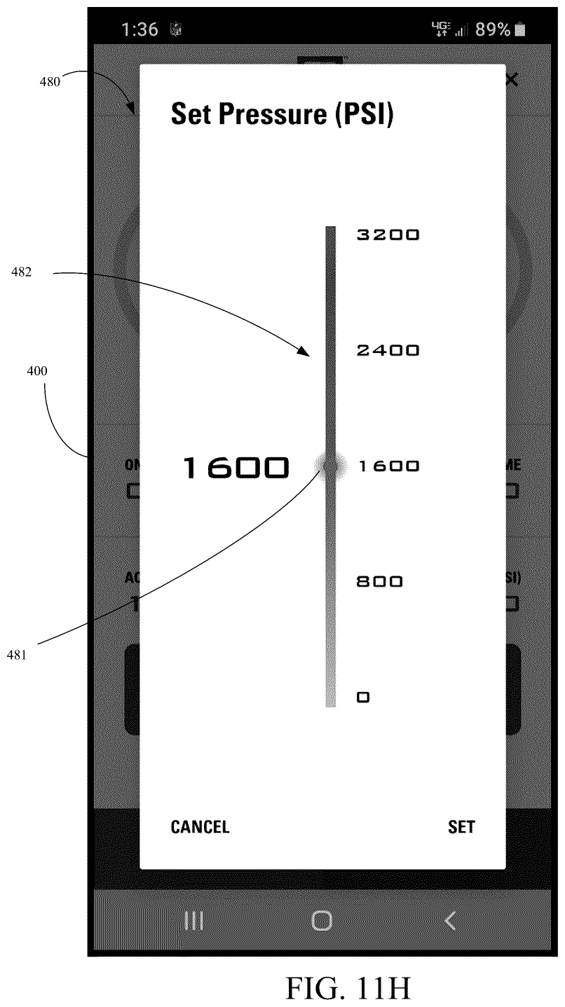

FIG. 11A is a diagrammatic view showing an example pump selection interface display 402. As shown, the interface is displayed on a mobile device 400 and shows two pump selection mechanisms 403 and 404 that a user can select from. Mobile device 400 may be similar to other mobile devices herein, such as, but not limited to mobile device 650. A user can also scroll further down to see additional pumps. Also, there is a menu button 405 used to alter characteristics of a pump and an ‘add’ interface mechanism 406 that allows a user to add another pump to the pump selection interface. As shown, each pump has an indicator of connectivity (407 and 408 respectively) in the top right, a title in the top center (409 and 410 respectively) and a sample image of the pump (411 and 412 respectively) in the center. Additionally, each pump selection mechanism has additional information, such as, a serial number 413, run time 414, last service date 415, etc. In other examples, each selection mechanism can include other items as well (e.g., a pump nickname or other identifier, additional images, etc.).

FIG. 11B is a diagrammatic view showing an example pump information interface display 420. As shown, the interface is on a mobile device 400, however the interface may be displayed on other devices as well. The interface shows information such as the title/model 421 of the pump and status of connectivity 422 at the top. Additionally, a photo of the pump 423 is provided. At the bottom are the serial number 424, running hours 425, last service date 426, and an option 427 to show more information about the pump. In other examples, this interface could show additional information such as, running hours using specific types of fluid, users that have used the pump, jobs the pump has been used on, etc.

At the bottom of the pump information window are prepare job 428 and start job mechanisms 429 which can be actuated to fulfill different functions. For example, actuating the prepare job mechanism can inform a user what they need to do to prepare for the next job (e.g., service the pump, change a filter or other component. etc.). Actuating the start job mechanism can bring a user to an interface 430 such as the one shown in FIG. 11C. The interface 430 of FIG. 11C allows the user to choose the type of tip that they will be using during the spraying operation. As shown, there are three specific tips selection mechanisms 431, 432, and 433 and one ‘other tip’ selection mechanism 434. Actuating one of these mechanisms will bring up further information on the tip and/or designate the tip as the tip to be used during the spray operation. In one example, this interface is not presented and instead the tip is automatically detected by the spray system. In another example, actuating one of the tip selection interface mechanisms brings a user to the interface 440 of FIG. 11D.

FIG. 11D is a diagrammatic view showing an example tip information interface display 440. As shown, the interface is displayed on a mobile device 400. As shown, an image of the tip 441 is provided, and a life of the tip 442 is presented at the top. This life can be calculated by the system, as it saves usage history of the tip. In some examples, a calculation is used to determine tip life. For example, a relationship between a pump RPM or pump reciprocation (e.g., frequency or speed) and pressure can estimate the size of the tip orifice and the size of the tip orifice has a relationship to the known manufactured orifice size of the tip. For instance, a model 517 tip has a manufactured orifice diameter of 0.017 inches and after 50% use the diameter size may be 0.019 inches. Therefore, if the system detects a 0.019-inch orifice on a model 517 tip the life can be adjusted to 50%.

The interface of FIG. 11D also allows user to change tips or proceed with the currently selected tip, as shown, by the buttons (443 and 444 respectively) on the bottom of interface of FIG. 11D. The interface of FIG. 11D may also include other tip identifying information such as a nickname, the last user to use the tip, the recommended types of fluid that this tip is used for, the job history this tip has been used on, etc.

FIG. 11E is a diagrammatic view showing an example tip sensing interface display 450. As shown, the interface 450 instructs a user to hold a smart tip next to the pump which can be read by a sensor on the pump. For instance, the spray tip may have an embedded RFID, NFC or other wireless communication device that the smart pump scanner can sense. In some examples, the smart tip has a barcode or number, QR code or other machine-readable identifier that the smart pump scanner can read. The pump can have an indicator (e.g., one or more lights, a display, audible device, etc.) that alerts the use the tip has been identified and also when the tip data is sent to the mobile device (e.g., the device that interface eleven a is displayed on). In other examples, the tip may be recognized in other ways as well.

FIG. 11F is a diagrammatic view showing an example surface selection interface display 460. As shown, there are several different surface types (illustratively shown as 461, 462, 463, 464, 465, 466, and 467) that the user can select from, identified by their industry standard names. In other examples, the user could select the surface type based on its given characteristics (e.g., porosity, absorption, flatness, etc.).

FIG. 11G is a diagrammatic view showing an example operating interface display 470. As shown, the current amount of paint used 471, and the area covered 472 is displayed. The paint use can be calculated based on the fluid throughput sensed through the pump (e.g., by calculating the pressure, orifice size, pump RPM. pump displacement, etc.) The area covered can be calculated based on the paint use and a motion sensor (e.g., IMU inertial measurement unit, gyroscope, accelerometers, camera, etc.) in the applicator. In some examples, the area covered can be calculated with a visual sensor (e.g., on the paint sprayer or elsewhere).

The interface 470 of FIG. 11G also displays the on-time 473, that is, the time that the system or pump has been powered on. The interface 470 of FIG. 11G also shows the runtime 474, that is, the time that the pump has been running to pump paint. The interface 470 of FIG. 11G also allows a user to change the pressure of the smart pump. As shown, there are interval mechanisms 475 and 476 allow a user to increase the pressure in intervals of 100 psi. In other examples, this could be changed to a different interval value as well (e.g., 50 psi, 250 psi, 1 bar, etc.). In one example, a user can actuate the manual set mechanism 479 which can generate an interface similar to that shown in FIG. 11H. Additionally, the pressure set 478 is displayed, and the actual pressure 477 is also displayed. In some examples, these pressures may be different which can indicate an error with the pump or other component.

FIG. 11H is a diagrammatic view showing an example pressure setting interface display 480. As shown, the pressure can be set by actuating an interface mechanism 481 along a scale 482. The scale 482 can correspond to the limits of the smart pump that the device is connected to. For instance, the max setting is shown to be three-thousand-two-hundred psi and the minimum is zero psi while the user has selected one-thousand-six-hundred psi as the operating pressure. In some examples, the scale corresponds to commonly used pressures (e.g., based on the fluid being applied, type of job, etc.) In other examples, the pressure can be set manually in other ways, such as typing in a value.

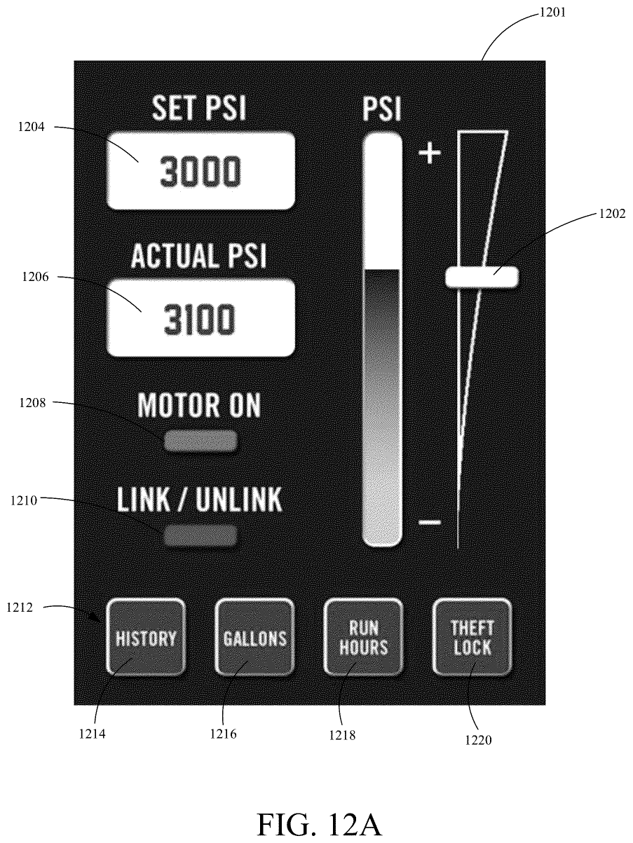

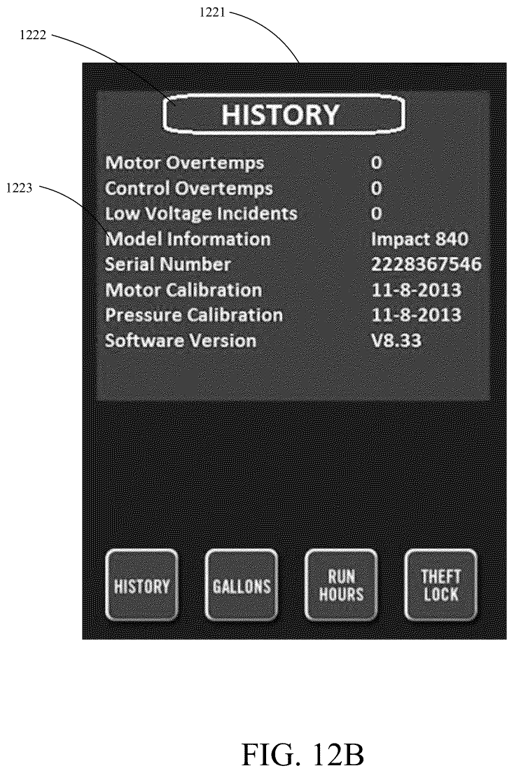

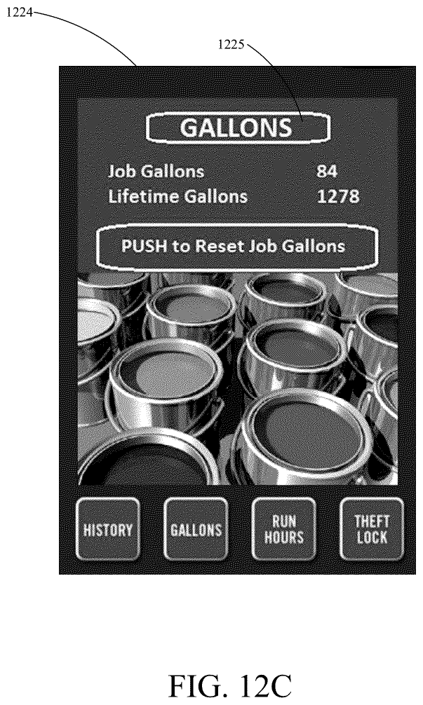

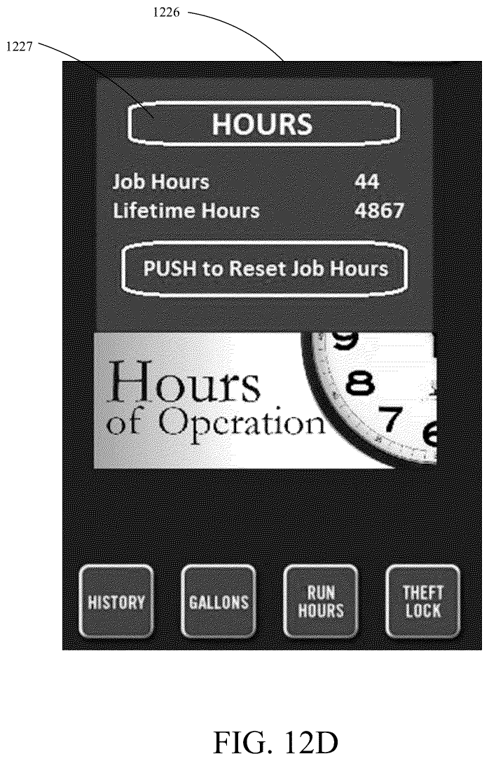

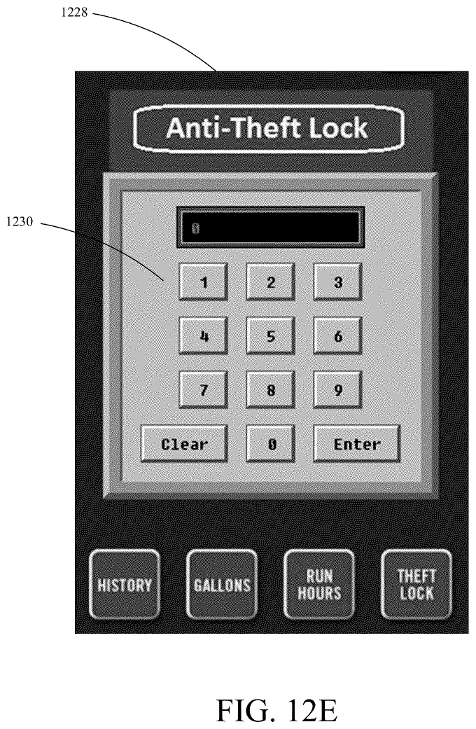

FIGS. 12A-E illustrate example user interfaces that can be displayed on a device (e.g., such as interface 200). FIG. 12A is a diagrammatic view showing an example home screen interface display 1201. As shown, display 1201 can be displayed on a mobile device and shows a pressure selection mechanism 1202 that a user that select and modify. More specifically, a user can set the pressure (e.g., psi) of a selected spraying system by adjusting the slider displayed on the right side of the display 1201. The slider can correspond to the limits of the smart pump to which the device is connected. In some examples, the scale corresponds to commonly used pressures (e.g., based on the fluid being applied, type of job, etc.) In the illustrated example, the pressure set by the user can be displayed in the “SET PSI” mechanism 1204. In other examples, the pressure can be set manually in other ways, such as typing in a value. Additionally, as shown in FIG. 12A, the actual pressure (e.g., sensed by a pressure sensor) of the spraying system can also be displayed on display 1201, as shown at reference numeral 1206. In this way, a user can visually compare the pressure differences between the set pressure and actual pressure of the selected spraying system.

As shown in FIG. 12A, the display 1201 can also include an indicator 1208 that indicates whether the motor is on, and an indicator 1210 that indicates whether the spraying system is linked to a device (e.g., the mobile device displaying display 1201). In one example, a mobile device can be linked to the spraying system via Bluetooth connection. However, it is expressly contemplated that the spraying system can be connected to a device in other ways as well, such as by Wi-Fi communication, cellular communication, etc. In the illustrated example, a color indicator can be used to determine whether the motor is running and/or whether the spraying system is linked to a device. For instance, a green indicator can indicate that the motor is operating, and a red indicator can indicate that the motor is not operating. Similarly, a green indicator can indicate that the spraying system is linked to a device, and a red indicator can indicate that the spraying system is not linked to a device. Additionally, it is expressly contemplated that other indicators can be utilized as well.

As shown in FIG. 12A, the display 1201 can also include one or more actuatable mechanisms (e.g., buttons) 1212 that allow a user to navigate to different interface windows or pages. For example, as shown in FIG. 12A, a user can navigate to a history interface display by pressing button 1214, a volume interface display by pressing button 1216, a run hours interface display by pressing button 1218, and an anti-theft interface display by pressing button 1220, which are further described below with respect to FIGS. 12B-12E.

FIG. 12B is a diagrammatic view showing an example spraying history interface display 1221. As shown, the display 1221 can be displayed on a mobile device and shows a system history 1222 list that a user can view. As illustrated, there are several events of the spraying system that can be recorded over time and displayed on the history interface display 1221. The spraying history interface display 1221 can include an indication of the number of times the motor and/or control has overheated. Additionally, the history interface display 1221 can include an indication of low voltage incidents. Also shown in FIG. 12B, the history interface display 1221 can also include information relevant to the particular spraying system being used, as indicated by reference numeral 1223. For example, the history interface display 1223 can display model information, a date of the most recent motor calibration, a date of the most recent pressure calibration, and an indication of the current software being utilized in the spraying system. Additionally, it is expressly contemplated that other events and/or parameters relevant to the spraying system can also be displayed on the history interface as well.

FIG. 12C is a diagrammatic view showing an example volume interface display 1224.

As shown, the volume interface display 1224 includes a display element 1225 that represents the volume of fluid used in gallons. However, in other examples, any other units can be utilized as well (e.g., liters, quarts, etc.). As shown, the interface display 1224 can include the volume of fluid (e.g., paint) used for the current job. For example, as shown in FIG. 12C, 84 gallons have been used for the current job. Additionally, the interface display 1224 can also include the volume of fluid used in the lifetime of the sprayer. For example, as shown, 1278 gallons of fluid have been used in the selected sprayer. The lifetime volume can be calculated with, for example, a sum of the fluid volume used for all of the jobs of the sprayer to date. Additionally, the volume interface display 1224 can also include a mechanism to reset the fluid volume of the current job.

FIG. 12D is a diagrammatic view showing an example run hours interface display 1226. As shown, the run hours interface display 1226 displays the time used for the job(s) in hours 1227. However, in other examples, any other time measurement can be utilized as well (e.g., minutes, seconds, etc.). As shown, the display 1226 can include the time used for the current job. For example, as shown in FIG. 12D, 44 hours have been used for the current job. Additionally, the display 1226 can also include the time that has been used in the lifetime of the sprayer. For example, as shown, 4867 hours have been used in the selected sprayer. The lifetime hours can be calculated by, for example, taking a sum of time used for all of the jobs of the selected sprayer to date. Additionally, the display 1226 can also include a mechanism to reset the job hours of the current job.

FIG. 12E is a diagrammatic view showing an example anti-theft interface display 1228. As shown, the anti-theft interface display 1228 can include a keypad 1229 in which a user can input a preset code in order to unlock access to the spraying system and the various interfaces described herein. In this way, display 1228 provides a security mechanism that prevents the spraying system and/or interfaces from unauthorized use. In one example, the theft lock code could be stored on the user's mobile device. In another example, the theft lock could also be stored in the sprayer. Alternatively, the theft lock code could be stored in the cloud as well. In operation, upon a user opening any of the interfaces described herein, a user can be prompted to input the theft lock code in order to continue with access to the given interface and/or spraying system. In one example, if an incorrect code is provided, the user may be locked from using the interface and/or spraying system. In another example, a theft report can be communicated to a remote device as well, indicative of the attempted access.

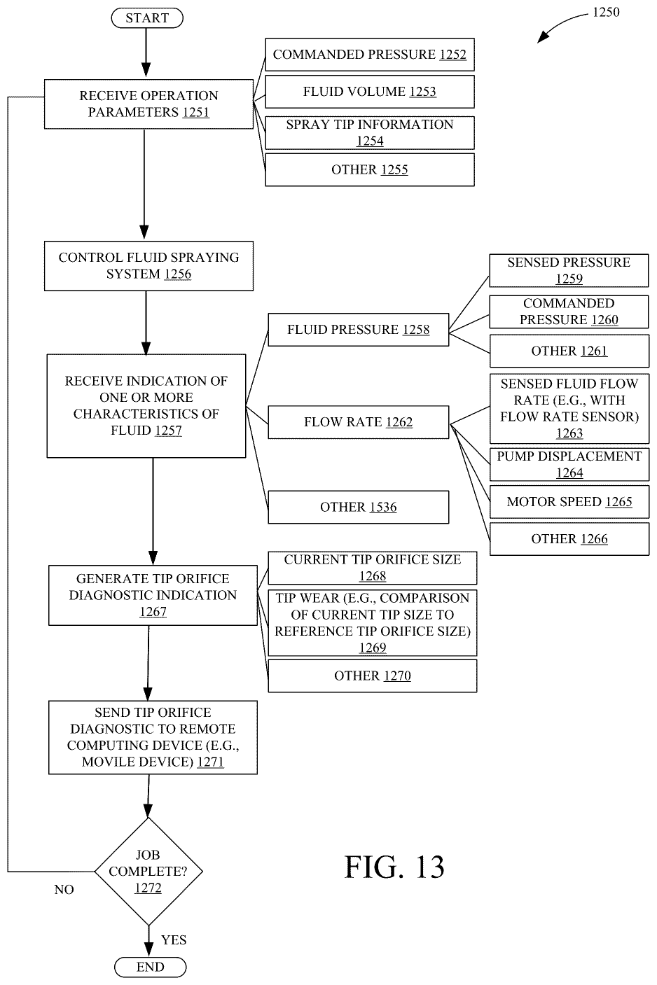

FIG. 13 is a flow diagram 1250 showing an example operation of a system that diagnoses a spray tip by generating a spray tip orifice diagnostic. The operation shown in flow diagram 1250 can be performed by a spray tip monitoring system, such as system 600. As noted herein, the functionality of system 600 can be distributed between one or more of a spraying system (such as spraying system 100 described above with respect to FIG. 6) a mobile device communicatively coupled to the spraying system (such as mobile device 650 described above with respect to FIG. 6) and/or a server. That is, in one example, some blocks of FIG. 13 can be performed by spraying system 100, while other blocks can be performed by mobile device 650 and/or a remote server. Alternatively, or in addition, the functionality of any one (or more) of the blocks can be distributed between spraying system 100, mobile device 650, and/or a remote server. Operation begins at block 1251, where operation parameters are received. The operation parameters received are indicative of the operational conditions for the particular spraying operation. For example, as indicated by block 1252, receiving the operation parameters can include receiving a commanded pressure. In another example, at block 1253, the operation parameters can also include an indication of the volume of fluid (e.g., a desired flow rate) to be sprayed during the spraying operation. As indicated by block 1254, the operation parameters can also include spray tip information. The spray tip information can be, for example, an indication of the type of spray tip (e.g., which indicates tip orifice size) being used for the operation. In another example, the spray tip information can be an indication that a spray tip has been connected such that the spraying system can proceed with operation. Additionally, it is expressly contemplated that other operation parameters can be received as well, as indicated by block 1255.

Operation 1250 proceeds to block 1256 where the spraying system is controlled or otherwise operated based on the spray tip information and/or operation parameters. Controlling the spraying system can include, for example, operating the motor at a selected motor speed to drive the pump to pump a fluid along a fluid path to the spray tip based on the commanded pressure and/or commanded flow rate. The spraying system can be controlled by, for example, control system 600 described above with respect to FIG. 6. In another example, the spraying system can be controlled utilizing a mobile device, such as mobile device 650.

Operation 1250 proceeds to block 1257 where at least one characteristic of the fluid along the fluid path to the spray tip is detected or otherwise identified. As indicated by block 1258, detecting a characteristic of the fluid can include, for example, detecting a fluid pressure indicative of a pressure of the fluid pumped along the fluid path to the spray tip. The fluid pressure can be, for example, a sensed pressure obtained from a pressure sensor that senses the fluid pressure as it travels along the fluid path to the spray tip, as indicated by block 1259. In another example, the fluid pressure can be determined based on the commanded pressure obtained at block 1252, as indicated by block 1260. Additionally, it is expressly contemplated that the fluid pressure can be detected in other ways as well, as indicated by block 1261.

As indicated by block 1262, obtaining a characteristic of the fluid can also include determining a flow rate of the fluid. The flow rate can be, for example, a sensed fluid flow rate that is sensed as fluid travels along the fluid path to the spray tip (e.g., with a fluid flow rate sensor), as indicated by block 1263. In another example, the flow rate can be detected based on an indication of an output of the pump of the spraying system. The indication of output can be, for instance, based on pump displacement, as indicated by block 1264. For instance, pump cycles can be monitored to determine the rate at which fluid is pumped through the fluid path and output from the spray tip. Alternatively, or in addition, the flow rate can be determined based on a detected motor speed of the spraying system motor, as indicated by block 1265. Additionally, it is expressly contemplated that flow rate can be determined in other ways as well, as indicated by block 1266.

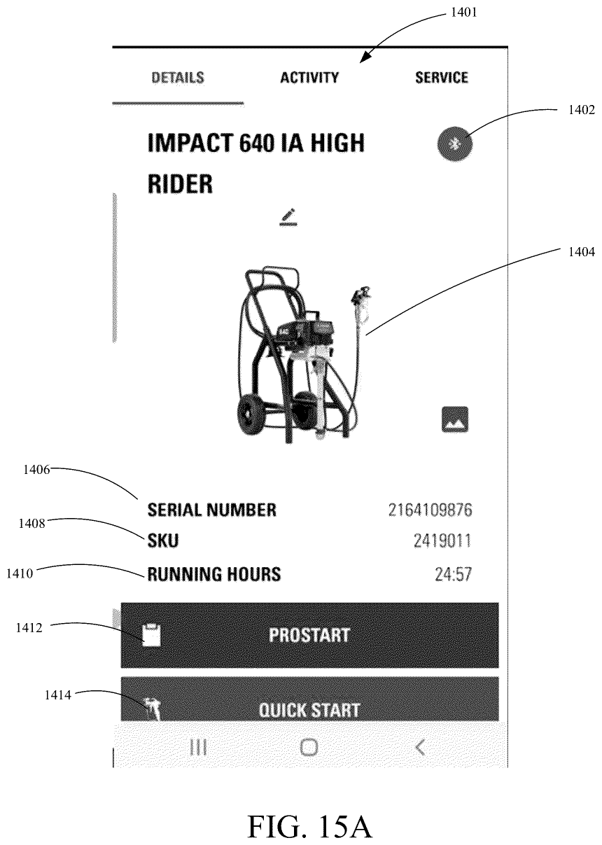

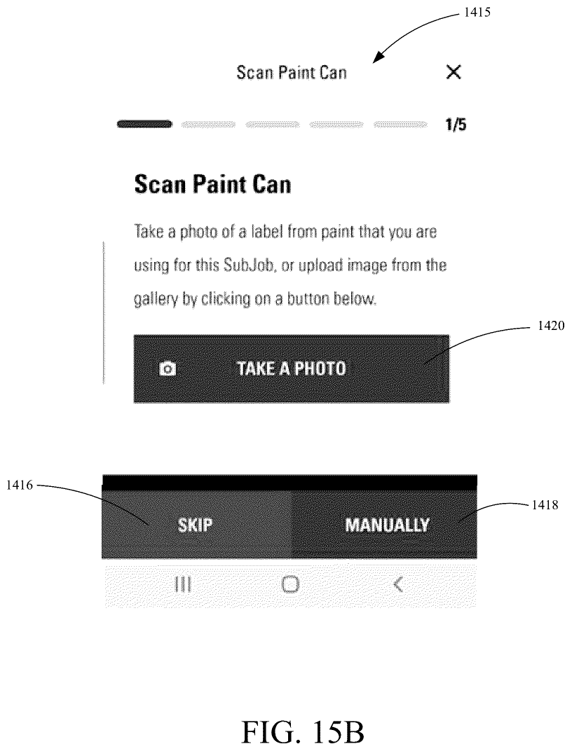

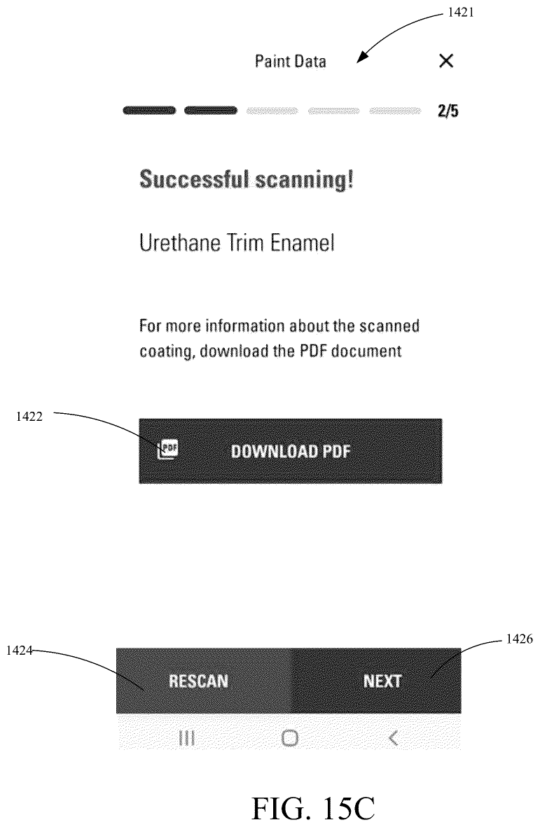

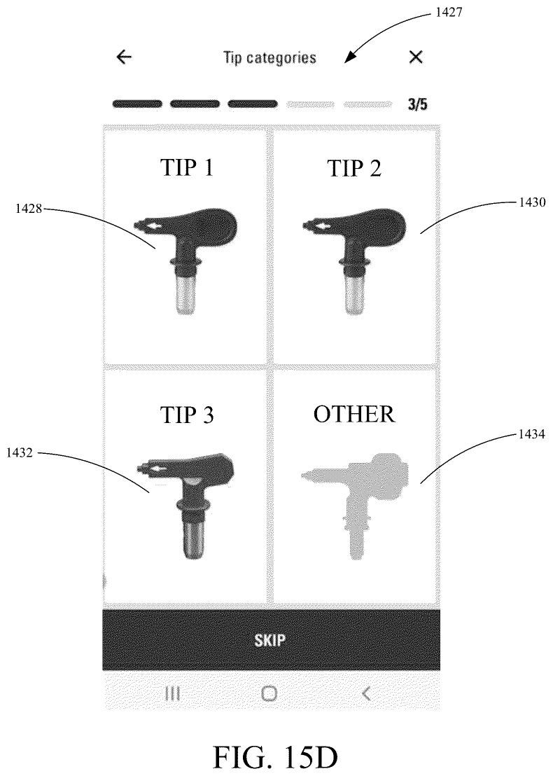

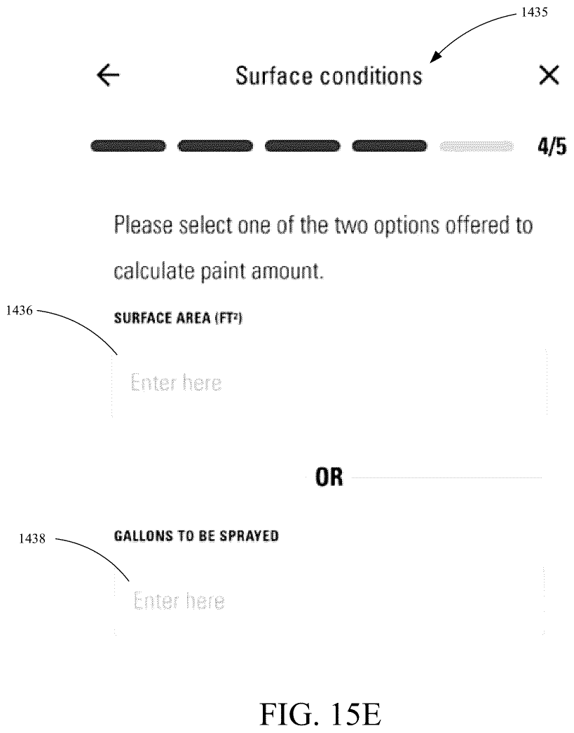

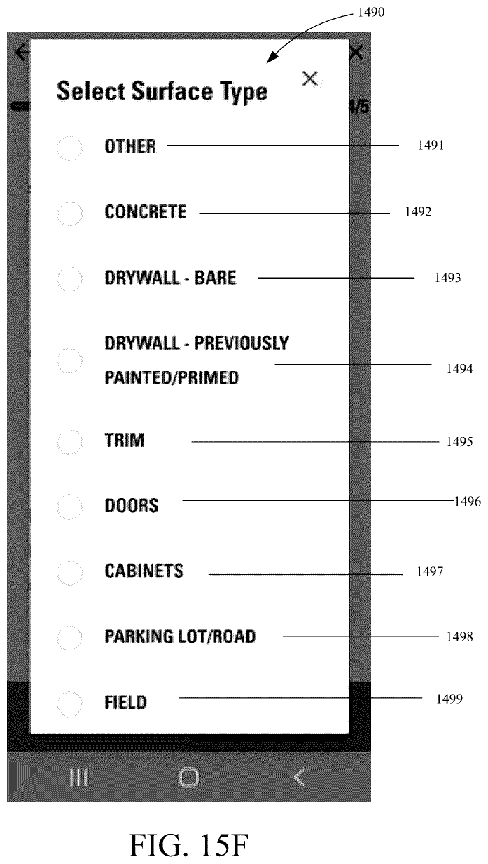

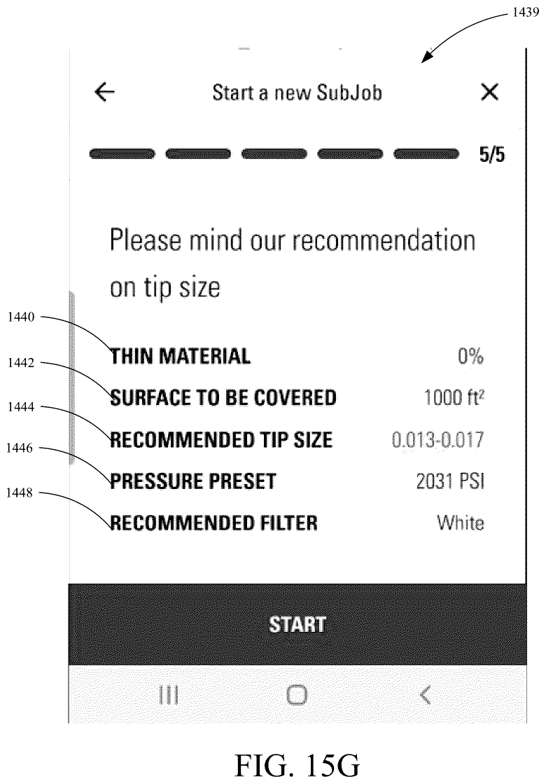

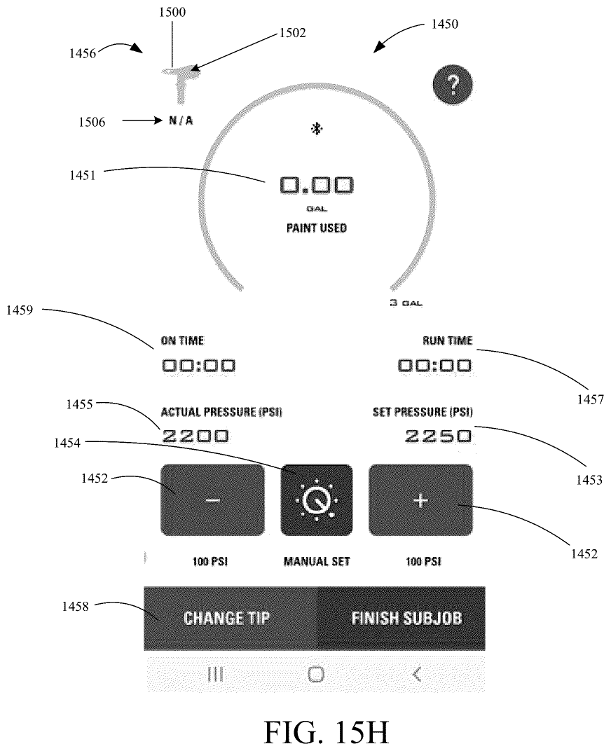

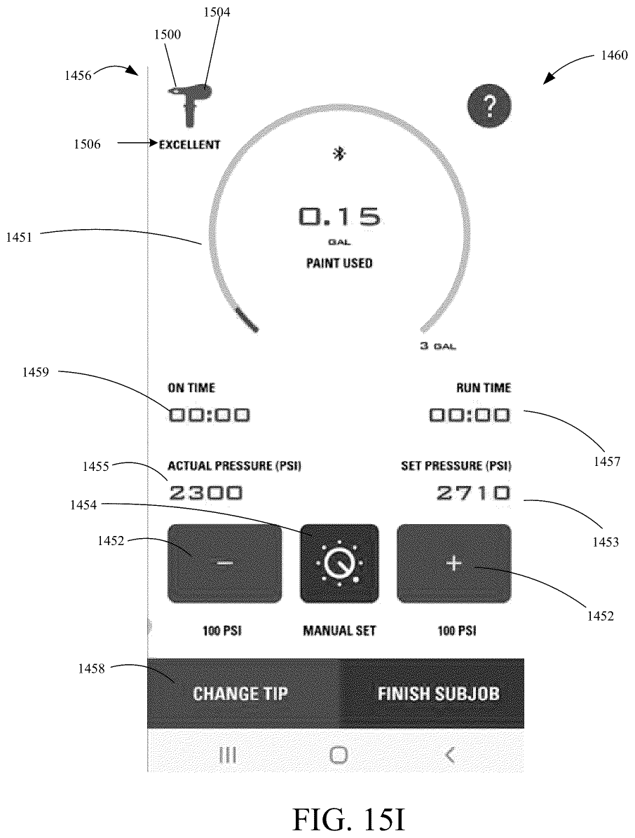

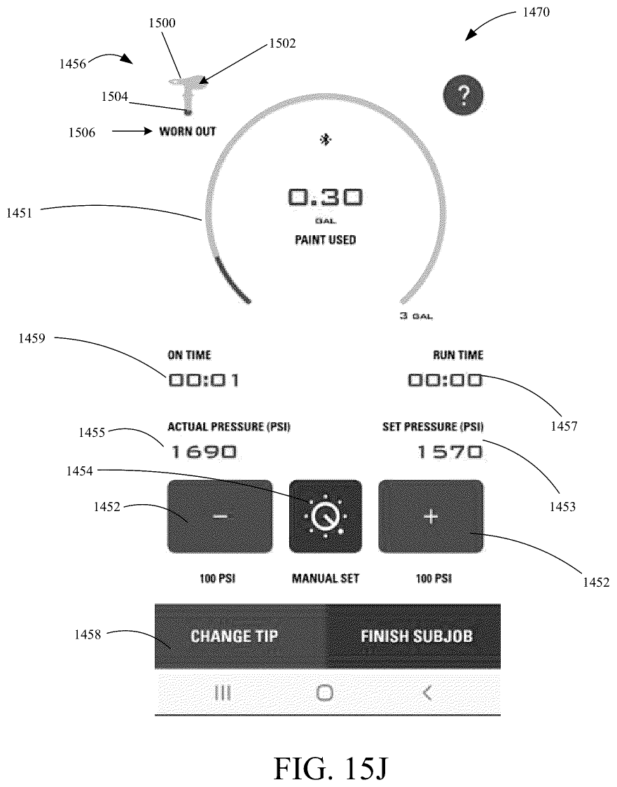

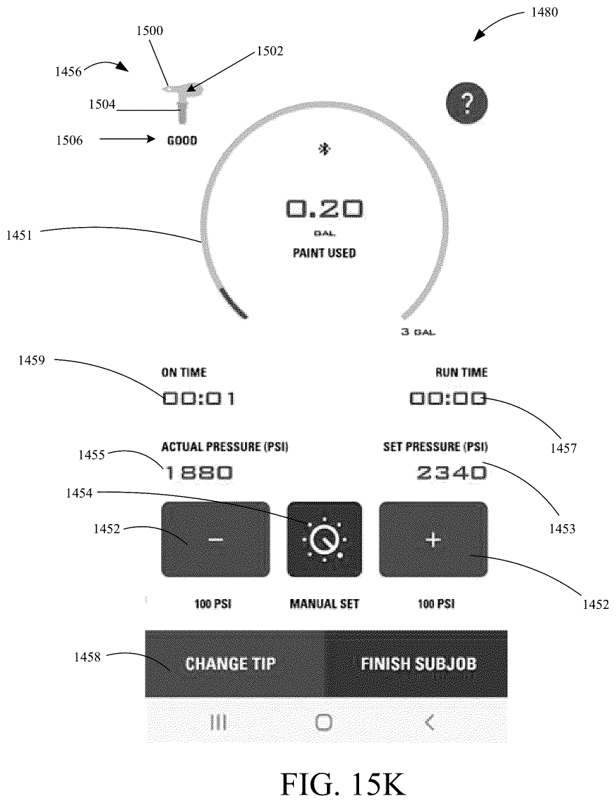

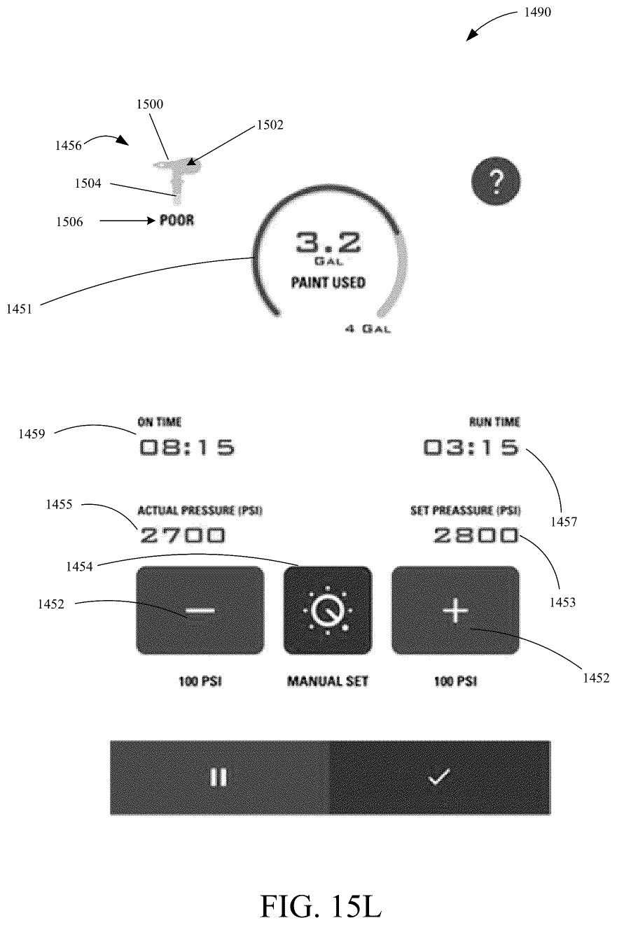

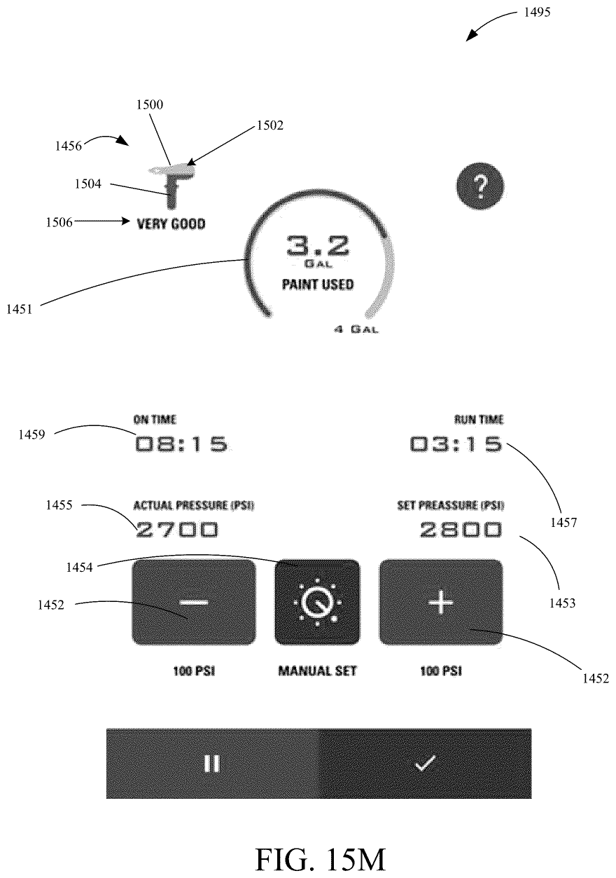

Operation 1250 proceeds to block 1267 where a tip orifice diagnostic indication is generated. Some examples of the tip orifice diagnostics are described in more detail below with respect to FIGS. 15A-15M. Briefly, however, generating the tip orifice diagnostic can include determining the current tip orifice size, as indicated by block 1268. For example, the current tip size can be determined by spraying system 100 based on the fluid pressure and the flow rate. In one example, the tip orifice size can be calculated using an orifice flow equation.

Additionally, generating the tip orifice diagnostic indication can include generating a tip wear indication, as indicated by block 1269. The tip wear indication can be generated by, for example, comparing a current tip orifice size to a reference tip orifice size, and providing the indication of the tip orifice diagnostic based on the comparison. The reference tip orifice size can be, for example, an operation standard or metric in which the tip orifice is expected to be at manufacture. Additionally, it is expressly contemplated that a different tip orifice diagnostic indication can be generated as well, as indicated by block 1270. In one example, block 1269 is performed by mobile device 650.

Operation 1250 proceeds to block 1271 where the tip orifice diagnostic is sent to a remote computing device. The remote computing device can be, for example, a remote server or a mobile device configured to display the tip orifice diagnostic indication on a display. Some examples of the tip orifice diagnostic indication being displayed is described in more detail below with respect to FIGS. 15H-15M.

Operation 1250 proceeds to block 1272, where it is determined if the job is complete. If so, then operation 1250 ends. If not, then operation 1250 proceeds at block 1251.

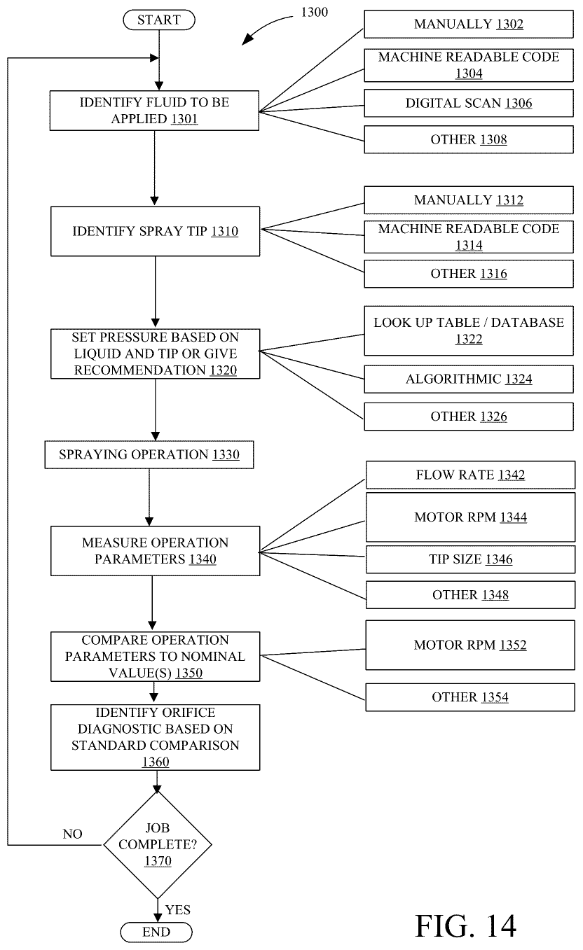

FIG. 14 is a flow diagram 1300 showing an example operation of a spraying system to generate a tip orifice diagnostic. The spraying system can be, for example, spraying system 100 described above with respect to FIG. 1. Operation 1300 begins at block 1301, where the fluid to be applied in a spraying operation is identified. The fluid can be identified by, for example, utilizing fluid identifying logic 604 described above with respect to FIG. 6. Identifying the fluid to be applied can also include identifying the volume of fluid to be applied. For example, the number of gallons of fluid to be applied can be identified by user input. Alternatively, or additionally, the volume of fluid can be determined from a user input of the area to be sprayed. Fluid can be identified in a number of ways. In one example, as indicated by block 1302, fluid can be manually identified. For instance, a user can select a fluid from a list of fluids on an interface (e.g., the interfaces described below with respect to FIGS. 15A-15M). Manual identification of a fluid can be used, for example, when a user intends to use water for the spraying operation to determine a tip orifice diagnostic. Additionally, manual identification can be used for a variety of different fluids as well.

As indicated by block 1304, fluid can also be identified by scanning a machine-readable code (e.g., a bar or QR code). The machine-readable code can be located on the fluid storage area, the fluid packaging, etc. The reader can be located on a mobile device, the fluid applicator (e.g., applicator 110) or some other device as well.

As indicated by block 1306, fluid can also be identified by a digital scan. A digital scan can include, for example, taking a photo of the fluid and/or fluid container and comparing it to a fluid database within a data store (e.g., data store 622) to identify the fluid. In another example, a video can be taken of the fluid and/or fluid container to identify the fluid to be used. An example of utilizing a digital scan to identify the fluid to be applied is described below with respect to FIGS. 15B-15C. Additionally, the fluid to be applied can be identified in other ways as well, as indicated by block 1308.

Operation 1300 proceeds as block 1310, where the spray tip is identified (e.g., tip 116 is identified by tip identifying logic 602). Tip 116 can be identified in a variety of different ways, as indicated by blocks 1312-1316. As indicated by block 1312, the tip can be identified manually. For example, a user can select the tip from a list of tips on an interface (e.g., the interface described below with respect to FIG. 15D). Additionally, the spray tip can be identified by scanning a machine-readable code (e.g., a bar or QR code), as indicated by block 1314. The bar or QR code can be located on the tip itself, the tip packaging, a tip storage area, etc. The tip can also be identified in other ways as well, as indicated by block 1316. For example, an image of the tip can be taken and analyzed by tip identifying logic 602 to identify the tip.

Operation 1300 proceeds at block 1320, where the pressure is set or recommended based on the identified fluid and tip. A recommendation can be made by, for example, recommendation logic 618 described above with respect to FIG. 6. The pressure can be retrieved from a lookup table or database of fluids and tips, as indicated by block 1322. The pressure can also be set based on an algorithm, as indicated by block 1324. The pressure can be set based on other items as well, as indicated by block 1326. By setting and/or recommending a set pressure to begin spraying at, the pressure is therefore defined and can be used in a tip orifice diagnostic calculation, described in further detail below. Specifically, by setting the pressure to a set amount, the motor speed (rpm) in order to maintain the set pressure can be measured relative to the selected spray tip, and thus a tip orifice diagnostic can be determined.

In some examples, the user can be informed of an incompatibility between the fluid and the tip. For instance, a recommendation can be made to the user to use a different tip/fluid combination for a better spray pattern. In one example, the user selects a desired type of atomization rate or pattern, and the system recommends a specific tip/fluid/pump setting combination to achieve the desired outcome.

Operation 1300 proceeds at block 1330 where the fluid is pumped from the pump 102 to the applicator, where it is sprayed at the pressure determined in block 1320. In one example, the pressure or setting is changed automatically (e.g., by control logic 620). In another example, the pressure or setting change is recommended to the user (e.g., by recommendation logic 618 and displayed on a display of the pump, mobile device, etc.). In another example, the pressure or setting change is made automatically, unless the user vetoes the change.

Operation 1300 proceeds at block 1340, where the spraying operation parameters are measured. As indicated above, by knowing the volume of fluid to be applied, the spray tip being used, and the set pressure of the spraying operation, flow rate can be calculated (e.g., by control system 600) and measured, as indicated by block 1342. The flow rate can be calculated by, for example, utilizing the conventional Bernoulli equation, reproduced below:

P₁+½ρν₁²+μgh₁=P₂+½ρν₂²+ρgh₂ Eq. 1

Where ρ refers to fluid density, g refers to acceleration due to gravity, P₁ refers to the pressure at a first elevation, ν₁ refers to the velocity at the first elevation, h₁ refers to the height at the first elevation, P₂ refers to the pressure at the second elevation, ν₂ refers to the velocity at the second elevation, and h₂ refers to the height at the second elevation.

Moreover, by calculating the flow rate of the fluid during the spraying operation, the motor speed (e.g., revolutions-per-minute (rpm)) required to maintain the flow rate at the set pressure can be determined in real-time, as indicated by block 1344. In operation, the motor speed being measured to maintain the flow rate at the set pressure can be compared to a standard in order to provide a tip orifice diagnostic, as further described below. For example, if the motor is operating at an expected speed to maintain the flow rate relative to the selected tip and pressure, this can be indicative of the tip being in excellent condition. In another example, if the motor is operating at a higher speed than expected to maintain the flow rate, this can be indicative of the tip being in poor and/or inferior condition. Additionally, other operation parameters can be measured as well, as indicated by block 1348.

The operation parameters can be measured in real-time by control system 600 in a number of different ways. For example, the operational parameters can be detected by sensors on the spraying system and/or mobile device. For instance, the motor speed can be measured by motor logic 613 and communicated to mobile device 650 in real-time. In another example, motor speed can be determined from an audio measurement by the mobile device, in which the sound emitted from the motor can be indicative of motor speed. In another example, motor speed can be determined from a video measurement by the mobile device, in which the motor speed can be visually determined. Additionally, it is expressly contemplated that the motor speed can be determined in other ways as well.

Operation 1300 proceeds at block 1350, where the operation parameters are compared to one or more nominal values. Comparing operation parameters to one or more nominal values allows for the provision of an orifice diagnostic. The nominal values can be, for example, an operation standard or metric in which the spraying system is expected to operate relative to the pressure setpoint, fluid volume, tip identification, and/or fluid flow rate. For instance, the nominal value can be an expected speed at which the motor should be operating to maintain the flow rate relative to the pressure setpoint and the tip. The one or more nominal values can be stored in, for example, data store 622, described above. As indicated by block 1352, comparing operation parameters can include comparing motor speed (e.g., rpm) to a nominal value. Specifically, as described above, if a motor is operating at an expected speed relative to the value, this can be indicative of a spray tip being in excellent condition. In another example, if a motor is operating at a higher speed relative to the nominal value, this can be indicative of a worn spray tip. Additionally, different operation parameters can be compared to other nominal values as well, as indicated by block 1354.

Operation 1300 proceeds at block 1360, where an orifice diagnostic is performed based on a comparison between the measured motor speed and a nominal value. As further described below with respect to FIGS. 15G-15M, the tip orifice can be diagnosed as either excellent, good, or worn out. Additionally, it is expressly contemplated that the tip orifice diagnostic can include other diagnoses as well. In one example, the tip orifice diagnostic can be displayed on a user interface, such as those described below with respect to FIGS. 15G-15M.

Operation 1300 proceeds at block 1370, where it is determined if the job is complete. If so, then operation 1300 ends. If not, then operation 1300 proceeds to block 1301.

FIGS. 15A-15M illustrate example user interfaces that can be displayed on a device (e.g., such as interface 200). FIG. 15A is a diagrammatic view showing an example pump information interface display 1401. As shown, the interface 1401 is on a mobile device. However, it is expressly contemplated that the interface 1401 can be displayed on other devices as well. The interface 1401 displays information such as the title/model of the pump and status of connectivity at the top. For example, as shown, a 640 IA High Rider is selected and connected via Bluetooth, as indicated by the indicator 1402 displayed near the top-right of the interface 1401. Additionally, a photo 1404 of the pump is provided. At the bottom are the serial number 1406, stock keeping unit (SKU) 1408, and running hours 1410. In other examples, this interface 1401 could show additional information, such as running hours using a specific type of fluid, users that have used the pump, jobs the pump has been used on, etc.

At the bottom of the pump information display are a pro-start 1412 and quick-start 1414 button, which can be actuated to fulfill different functions. For example, actuating the pro-start button can allow a user to proceed with the next steps of starting a spraying job and executing a tip orifice diagnostic, as set forth above with respect to FIG. 13. Additionally, actuating the quick-start button can allow a user to bypass the prerequisite steps set forth below with respect to FIGS. 15B-15M and proceed with the spraying operation. Selecting the pro-start button allows a user to proceed with determining and/or selecting fluid to be used for the spraying operation, as set forth below with respect to FIG. 15B.

FIG. 15B is a diagrammatic view showing an example fluid selection interface display 1415. As shown, the interface 1415 includes a button 1420 that allows a user to perform a digital scan on a fluid container to determine the fluid to be used for a spraying operation. Additionally, if the fluid to be used does not have a scannable container, a button 1416 is disposed at the bottom that allows a user to skip the digital scan step. Further, an additional button 1418 is disposed near the bottom of the interface 1415 that enables a user to manually select a fluid to be used (e.g., water). While the example shown in FIG. 15B utilizes a photo digital scan, it is expressly contemplated that another form of digital scan can be utilized as well, such as a video or previously captured image.

FIG. 15C is a diagrammatic view showing an example scan result interface display 1421. As shown in FIG. 15C, the interface 1421 indicates that the digital scan was successful. Specifically, in the present example, a urethane trim enamel was successfully scanned for the spraying operation. In one example, the interface also includes a button 1422 that allows a user to download a document (e.g., portable document format (pdf)) containing information pertaining to the fluid to be used. Additionally, the interface 1421 can also include a button 1424 disposed near the bottom of the display to retry the digital scan, or to proceed with the spraying operation 1426.

FIG. 15D is a diagrammatic view showing an example tip selection interface display 1427. Actuating button 1426 in FIG. 15C can bring a user to the interface 1427 shown in FIG. 15D. The interface 1427 allows the user to choose the type of tip that they will be using during the spraying operation. As shown, there are three specific tip selection buttons 1428, 1430, and 1432, and one “other tip” selection button 1434. Actuating one of these buttons will bring up further information on the tip and/or designate the tip as the tip to be used during the spray operation. Each tip has a designated and known tip nominal orifice diameter that can be used in a tip orifice diagnostic. The known tip nominal orifice diameter can be, for example, a known manufactured orifice size of the tip. For instance, a model 517 tip has a manufactured orifice diameter of 0.017 inches. In one example, this interface 1427 is not presented, and instead the tip is automatically detected by the spraying system. In another example, actuating one of the tip selection interface buttons 1428-1434 brings a user to the interface of FIG. 15E.

FIG. 15E is a diagrammatic view showing an example surface condition interface display 1435. As shown at the top of the display, the interface 1435 follows the step previously discussed with respect to FIG. 15D. As indicated in the interface display 1435, there is a mechanism 1436 that prompts a user to input parameters that will be used in a fluid amount calculation. Specifically, in the present example, a user can input the area 1436 of the surface to be sprayed with fluid. As shown, the surface area is calculated in square-feet. However, in other examples, different area measurements can be used as well. Alternatively, or additionally, a user can input the gallons of fluid to be sprayed, as indicated by reference numeral 1438. By inputting a parameter that can be used to calculate fluid volume, the fluid volume can consecutively be used in a flow rate and tip orifice diagnostic calculation, as described above with respect to FIG. 14.

FIG. 15F is a diagrammatic view showing an example surface selection interface display 1490. As shown, there are several different surface types (illustratively shown as 1491, 1492, 1493, 1494, 1495, 1496, 1497, 1498, and 1499) that the user can select from, identified by their industry standard names. In other examples, the user could select the surface type based on its given characteristics (e.g., porosity, absorption, flatness, etc.).

FIG. 15G is a diagrammatic view showing an example tip recommendation interface display 1439. As shown, the interface 1439 can include an indication of the parameters input by the user in the interface examples previously described above with respect to FIGS. 15A-15F. For example, as shown in FIG. 15G, a material indication 1440 and surface indication 1442 is displayed. Additionally, as shown at reference numeral 1444, the interface 1439 can also display a recommended tip size to the user based on the parameters received above with respect to FIGS. 15A-15F. In one example, the tip size recommendation 1444 can be a tip size range. However, in another example, a single tip size recommendation can also be displayed. The recommendation can be generated by recommendation logic 618 described above with respect to FIG. 6. In one example, the tip size recommendation can be retrieved from a lookup table or database of tips. In another example, the tip size recommendation can also be set based on an algorithm. Additionally, it is expressly contemplated that the tip size recommendation can be retrieved in other ways as well.

As shown in FIG. 15G, the interface 1439 can also include a pressure preset indication 1446, which indicates a preset pressure the spraying system will be set to prior to the spraying operation. Additionally, the interface 1439 can also include a filter recommendation 1448, which indicates to a user a recommended filter to be used during the spraying operation.

FIG. 15H is a diagrammatic view showing an example operating interface display 1450. As shown, the current amount of paint used is displayed at reference numeral 1451. The paint used can be calculated based on the fluid sensed through the pump (e.g., by calculating the pressure, orifice size, pump RPM, pump displacement, etc.). The area covered can be calculated based on the paint use and a motion sensor (e.g., IMU inertial measurement unit, gyroscope, accelerometers, camera, etc.) in the applicator. In some examples, the area covered can be calculated with a visual sensor (e.g., on the paint sprayer or elsewhere).

The interface 1450 of FIG. 15H also displays the on-time 1459, that is, the time that the system or pump has been powered on. The interface 1450 of FIG. 15H also shows the runtime 1457, that is, the time that the pump has been running to pump paint. The interface 1450 of FIG. 15H also allows a user to change the pressure of the smart pump. As shown, there are buttons 1452 that that allow a user to increase and/or decrease the pressure in intervals of 100 psi. In other examples, this could be changed to a different interval value as well (e.g., 50 psi, 250 psi, 1 bar, etc.). In one example, a user can actuate the manual set mechanism 1454, which can generate an interface similar to that shown in FIG. 11H. Additionally, the pressure set 1453 is displayed, and the actual pressure 1455 is also displayed. In some examples, these pressures may be different which can indicate an error with the pump or other component.

As shown in FIG. 15H, the interface display 1450 also includes a tip orifice diagnostic display element 1456, illustratively displayed near the top-left of the display 1450. Of course, display element 1456 can be displayed elsewhere on display 1450, and in other forms as well.

The tip orifice diagnostic display element 1456 indicates the tip orifice diagnostic generated at, for example, blocks 1267 in FIGS. 13 and/or 1360 in FIG. 14. The tip orifice diagnostic represented by display element 1456 can take any of a variety of forms. For example, display element 1456 can indicate the current tip orifice size (e.g., orifice diameter) calculated based on the fluid pressure and flow rate through the spray tip. In one particular example, display element 1456 can visually indicate a numerical value (e.g., “0.017” inches) that indicates the diameter of the spray tip. This, of course, is for sake of example only.

In another example, display element 1456 can indicate the tip orifice diagnostic as an indication of tip wear. For example, the actual spray tip orifice size can be compared to a reference orifice size, such as a nominal or manufactured tip size. Accordingly, display element 1456 can indicate the tip wear in terms of a percentage or ratio of the actual tip size compared to the initial or reference tip size. For sake of illustration, if a spray tip with a manufactured orifice diameter of 0.017 inches has a current measured diameter size of 0.019 inches, then a wear metric of 50% can be generated and visually identified by display element 1456. In another example, the tip wear can be classified based on the current tip size falling into one of a plurality of different classification ranges. For example, a tip wear above 80% can be classified as “excellent”, a tip wear between 80% and 50% can be classified as “good”, and a tip wear below 50% can be classified as “poor” or “worn out.” These, of course, are for sake of example only.

As shown in FIG. 15H, the current tip wear is listed as not-applicable (N/A), indicating that the diagnostics have not yet been performed. As further described below, during the spraying operation, a tip orifice diagnostic can be performed in real-time via the operation described above with respect to FIG. 13. Additionally, as shown on the interface, a button 1458 is disposed near the bottom of the display to allow a user to change the spray tip, if desired. In one example, actuating the button 1458 to change the spray tip may direct the user to the interface described above with respect to FIG. 15D.

As is shown in FIG. 15H and as will be shown in more detail in FIGS. 15I-15M, tip diagnostic display element 1456 comprises a gauge display element 1500 in the shape of a spray tip. The gauge display element defines a graphical volume 1502 that is filled by a fill element 1504 (shown in FIGS. 15I-15K) to indicate the tip wear. Tip diagnostic display element 1456 also includes an associated metric display element 1506 that provides a textual display of a tip wear metric (e.g., words, letters, numbers, etc.).

FIG. 15J is a diagrammatic view showing an example operating interface display 1460. FIG. 15J has some similarities to the interface discussed above with respect to FIG. 15H. However, as shown near the top-left of the interface 1460, tip orifice diagnostic display element 1456 indicates a tip wear of ‘ excellent’. As shown in FIG. 15J, metric display element 1506 comprises the word “excellent.” Additionally, the volume 1502 of gauge display element 1500 has been filled (completely as shown in the example) by fill element 1504 to indicate the wear of the spray tip. Fill element 1504 can be colored to further indicate the wear of the spray tip (in the illustrated example, fill element 1504 is colored green to indicate the tip wear as being excellent). In the illustrated examples shown herein, the greater extent to which the fill element 1504 fills the volume 1502 of the gauge display element 1500, the better the wear condition of the spray tip. As shown in FIG. 15J, an amount of fluid has been used in a spraying operation such that a tip orifice diagnostic can be identified. Specifically, in the present example, 0.15 gallons of fluid has been used. However, in other examples, a different amount of fluid can be used to determine the tip orifice diagnostic as well.

FIG. 15J is a diagrammatic view showing an example operating interface display 1470. FIG. 15J has many similarities to the interface discussed above with respect to 15H. However, as shown near the top-left of the interface 1470, tip orifice diagnostic display element 1456 indicates a tip wear of ‘worn out’. As shown in FIG. 15J, metric display element 1506 comprises the words “worn out”. Additionally, the volume 1502 of gauge display element 1500 has been filled to a given extent by fill element 1504 to indicate the wear of the spray tip. As shown in FIG. 15J, the gauge display element 1500 appears nearly empty to indicate that the spray tip is worn out and further, the fill element 1504 is colored (red in the illustrated example) to indicate the tip wear as being “worn out”. As shown in FIG. 15J, an amount of fluid has been used in a spraying operation such that a tip orifice diagnostic can be identified.

FIG. 15K is a diagrammatic view showing an example operating interface display 1480. FIG. 15K has many similarities to the interface discussed above with respect to FIG. 15H. However, as shown near the top-left of the interface 1480, tip orifice diagnostic display element 1456 indicates a tip wear of ‘good’. As shown in FIG. 15K, metric display element 1506 comprises the word “good”. Additionally, the volume 1502 of gauge display element 1500 has been filled to a given extent by fill element 1504 to indicate the wear of the spray tip. As shown in FIG. 15K, the gauge display element 1500 appears about half full to indicate that the spray tip is good and further, the fill element 1504 is colored (green in the illustrated example (though a lighter green than the green shown in FIG. 15I)) to indicate the tip wear as being “good”. As shown in FIG. 15K, an amount of fluid has been used in the spraying operation such that a tip orifice diagnostic can be identified.

FIG. 15L is a diagrammatic view showing an example operating interface display 1490. FIG. 15L has many similarities to the interface discussed above with respect to FIG. 15H. However, as shown near the top-left of the interface 1490, tip orifice diagnostic display element 1456 indicates a tip wear of ‘poor’. As shown in FIG. 15L, metric display element 1506 comprises the word “poor”. Additionally, the volume 1502 of gauge display element 1500 has been filled to a given extent by fill element 1504 to indicate the wear of the spray tip. As shown in FIG. 15L, the gauge display element 1500 appears about a quarter full to indicate that the spray tip is in poor condition and further, the fill element 1504 is colored (yellow in the illustrated example) to indicate the tip wear as being “poor”. As shown in FIG. 15L, an amount of fluid has been used in the spraying operation such that a tip orifice diagnostic can be identified.

FIG. 15M is a diagrammatic view showing an example operating interface display 1495. FIG. 15M has many similarities to the interface discussed above with respect to FIG. 15H. However, as shown near the top-left of the interface 1495, tip orifice diagnostic display element 1456 indicates a tip wear of ‘very good’. As shown in FIG. 15M, metric display element 1506 comprises the words “very good”. Additionally, the volume 1502 of gauge display element 1500 has been filled to a given extent by fill element 1504 to indicate the wear of the spray tip. As shown in FIG. 15M, the gauge display element 1500 appears about three quarters full to indicate that the spray tip is in very good condition and further, the fill element 1504 is colored (green in the illustrated example (though a darker green than the green shown in FIG. 15K and a lighter or same green as the green shown in FIG. 15I)) to indicate the tip wear as being “very good”. As shown in FIG. 15M, an amount of fluid has been used in the spraying operation such that a tip orifice diagnostic can be identified.

In interface display examples described above with respect to FIGS. 15H-15M, example tip orifice diagnostic classifications of ‘excellent’, ‘good’, ‘worn out’, ‘very good’, and ‘poor’ are displayed. In some examples, the noted orifice diagnostic indications can be indications of the tip size and/or tip wear relative to an orifice diagnostic metric. For example, an indication of ‘excellent’ can correspond to the tip being at a size such that the motor is operating at or near a nominal value. The nominal value can be, for example, an expected motor speed at which the motor should be running relative to the identified tip. Additionally, an indication of ‘good’ can correspond to the tip being at a size such that the motor is operating at 20% faster than the nominal value, and an indication of ‘worn out’ can correspond to the tip being at a size such that the motor is operating at more than 20% faster than the nominal value. In one example, rather than utilizing the classifications, the tip orifice diagnostic indication can instead be an indication of the orifice size of the tip. For instance, the tip orifice size can be displayed visually on the. In another example, a tip orifice size range can also be displayed, similar to that described above with respect to FIG. 15G.

In another example, the orifice diagnostic indication can instead be based on ranges of motor speed. Additionally, the tip orifice diagnostic indication can be listed as a percentage condition of the tip. For instance, a model 517 tip has a manufactured orifice diameter of 0.017 inches and after 50% use the diameter size may be 0.019 inches. Therefore, if the system detects a 0.019-inch orifice on a model 517 tip, the orifice diagnostic indication can be adjusted and displayed to read 50%. The tip orifice diagnostic indication can be displayed visually utilizing, for example, indicator 1456 described above with respect to FIGS. 15H-15M.

Additionally, while the examples of metric display element 1506 shown in FIGS. 15H-15M comprise word(s), in other examples, metric display element 1506 can display numerical values (e.g., percentages, tip size values, etc.).

At least some examples are described herein in the context of applying a coating material, such as paint, to a surface. As used herein, paint includes substances composed of coloring matter or pigment suspending in a liquid medium as well as substances that are free of coloring matter or pigment. Paint can also include preparatory coatings, such as primers. Paint can be applied to coat a surface as a liquid or a gaseous suspension, for example, and the coating provided can be opaque, transparent, or semi-transparent. Some particular examples include, but are not limited to, latex paint, oil-based paint, stain, lacquers, varnish, inks, and the like. At least some examples can be applied in plural components systems. For example, multiple identification devices identify the plurality of components used in the plural component system.

It should also be noted that the different examples described herein can be combined in different ways. That is, parts of one or more examples can be combined with parts of one or more other examples. All of this is contemplated herein.

It will be noted that the above discussion has described a variety of different systems, components and/or logic. It will be appreciated that such systems, components and/or logic can be comprised of hardware items (such as processors and associated memory, or other processing components, some of which are described below) that perform the functions associated with those systems, components and/or logic. In addition, the systems, components and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components and/or logic described above. Other structures can be used as well.

The present discussion has mentioned processors and servers. In one embodiment, the processors and servers include computer processors with associated memory and timing circuitry, not separately shown. They are functional parts of the systems or devices to which they belong and are activated by and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

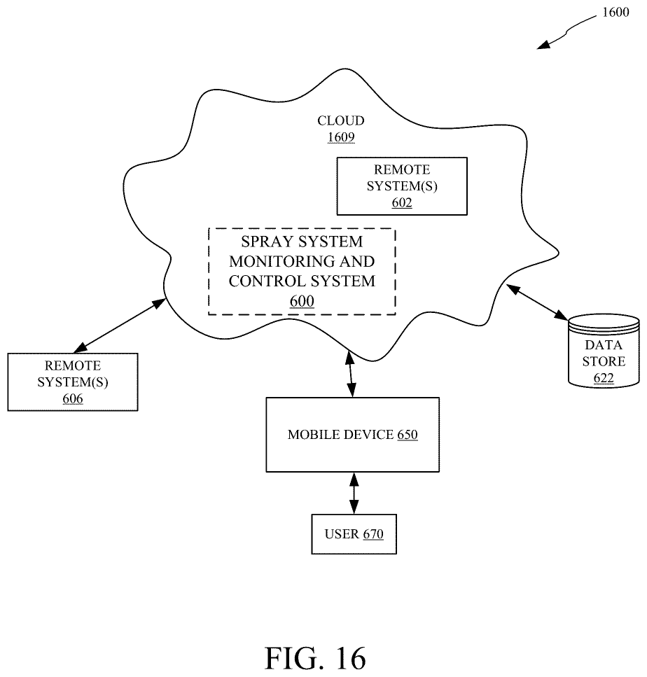

FIG. 16 is a block diagram of spraying system environment 99, shown in FIG. 6, deployed in a remote server architecture 1600. In an example, remote server architecture 1600 can provide computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network, and they can be accessed through a web browser or any other computing component. Software or components shown in FIG. 6 as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they can be provided from a conventional server, or they can be installed on client devices directly, or in other ways.

In the example shown in FIG. 16, some items are similar to those shown in FIG. 6 and they are similarly numbered. FIG. 6 specifically shows that spray system monitoring and control system 600 can be located at a remote server location 1609. Alternatively, or in addition, one or more of remote systems 611 and/or data stores 622 can be located at the remote server location 702. Therefore, mobile device 650, user 670, spraying system 100, and other components access those systems through remote server location 1509.

FIG. 16 also depicts another example of a remote server architecture. FIG. 16 shows that it is also contemplated that some elements of FIG. 6 are disposed at remote server location 702 while others are not. By way of example, spray system monitoring and control system 600 can be disposed at a location separate from location 702 and accessed through the remote server at location 702. Further, one or more of data stores 622 can be disposed at a location separate from location 1209 and accessed through the remote server at location 1609. Regardless of where they are located, they can be accessed directly by spraying system 100, through a network (either a wide area network or a local area network), they can be hosted at a remote site by a service, or they can be provided as a service, or accessed by a connection service that resides in a remote location.

It will also be noted that the elements of FIG. 6, or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

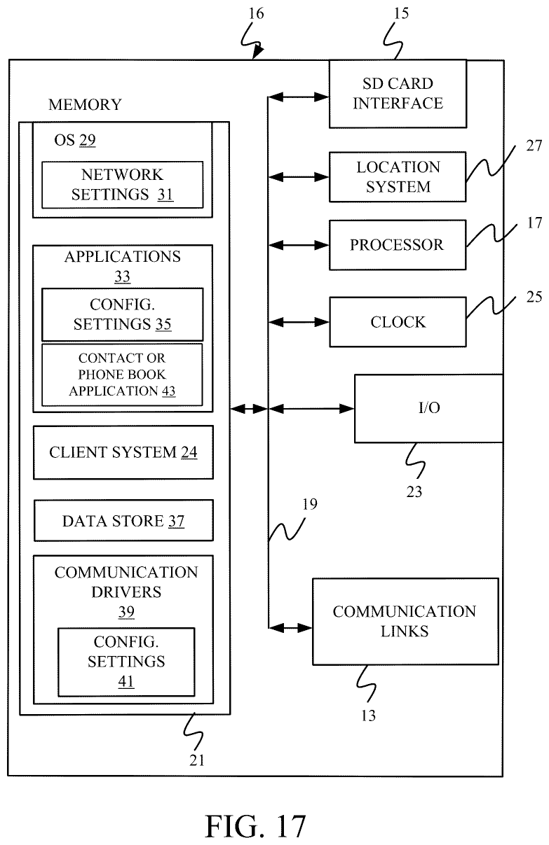

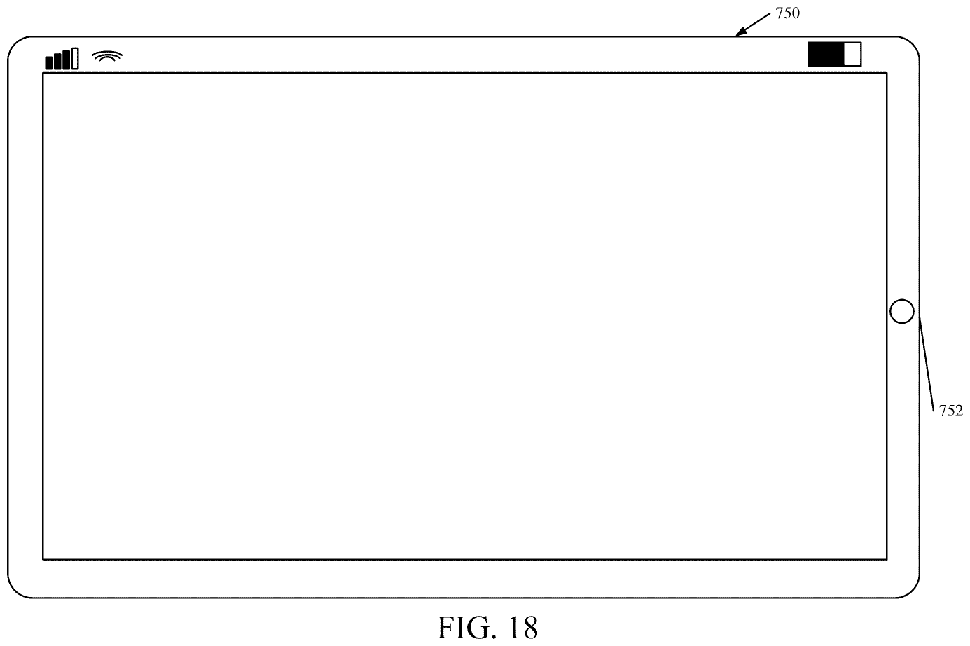

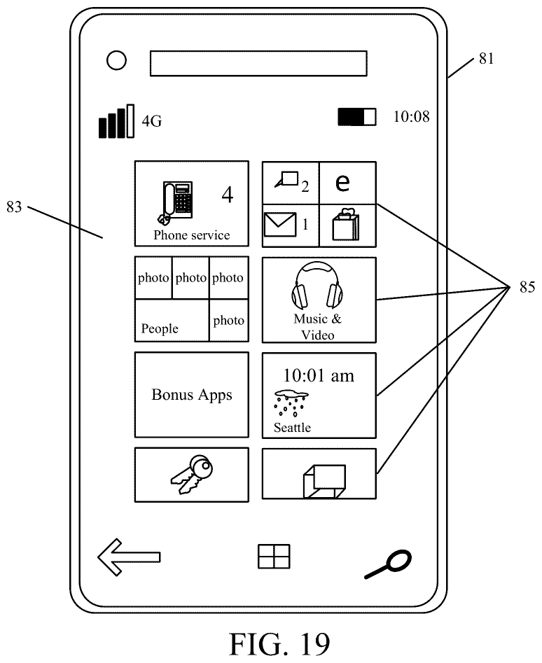

FIG. 17 is a simplified block diagram of one illustrative example of a handheld or mobile computing device that can be used as a user's or client's device 16, in which the present system (or parts of it) can be deployed. FIGS. 18-19 are examples of handheld or mobile devices.

FIG. 17 provides a general block diagram of the components of a device 16 that can run some components shown in FIG. 6, that interacts with them, or both. In the device 16, a communications link 13 is provided that allows the handheld device to communicate with other computing devices and under some embodiments provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communications link 13 communicate with a processor 17 (which can also embody processors or servers from previous FIGS.) along a bus 19 that is also connected to memory 21 and input/output (I/O) components 23, as well as clock 25 and location system 27.

I/O components 23, in one example, are provided to facilitate input and output operations. I/O components 23 for various embodiments of the device 16 can include input components such as buttons, touch sensors, optical sensors, microphones, touch screens, proximity sensors, accelerometers, orientation sensors and output components such as a display device, a speaker, and or a printer port. Other types of I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

FIG. 18 shows one example in which device 16 is a tablet computer 750. In FIG. 18, computer 750 is shown with user interface display screen 752. Screen 752 can be a touch screen or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 750 can also illustratively receive voice inputs as well.

FIG. 19 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone. Note that other forms of device 16 are possible.

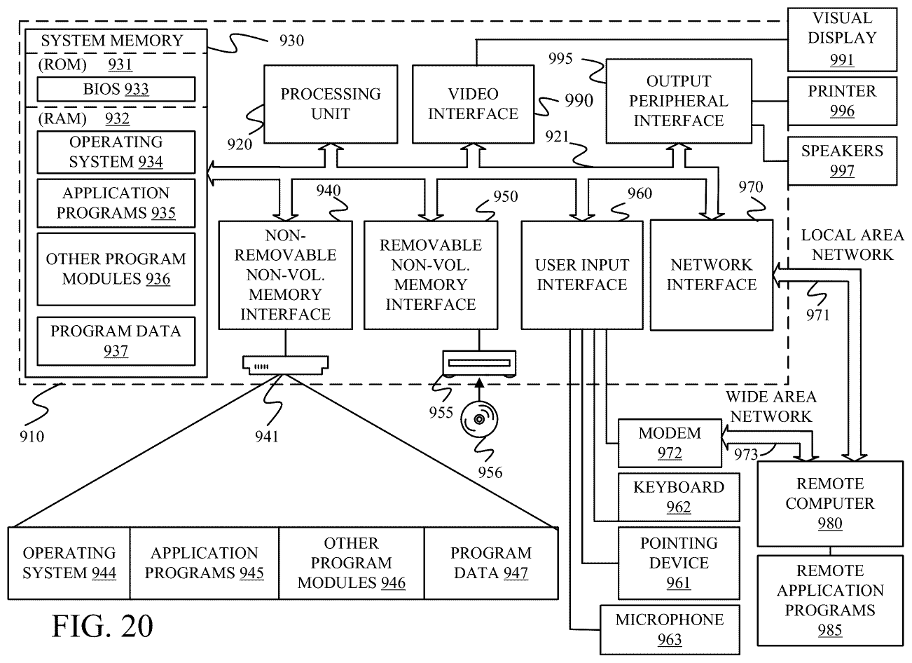

FIG. 20 is one example of a computing environment in which elements of FIG. 6, or parts of it, (for example) can be deployed. With reference to FIG. 20, an example system for implementing some embodiments includes a computing device in the form of a computer 810. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory and programs described with respect to FIG. 6 can be deployed in corresponding portions of FIG. 20.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 830 includes computer storage media in the form of volatile and/or nonvolatile memory such as read only memory (ROM) 831 and random-access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 20 illustrates operating system 834, application programs 835, other program modules 836, and program data 837.

The computer 810 may also include other removable/non-removable volatile/nonvolatile computer storage media. By way of example only, FIG. 16 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840, and optical disk drive 855 is typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 20, provide storage of computer readable instructions, data structures, program modules and other data for the computer 810. In FIG. 20, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a local area network—LAN, or wide area network—WAN or a controller area network-CAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 17 illustrates, for example, that remote application programs 885 can reside on remote computer 880.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts mentioned above are disclosed as example forms of implementing the claims.

What is claimed is:

1. A system comprising:
a fluid spray gun comprising a spray tip having a tip orifice;
a pump configured to pump fluid along a flow path to the fluid spray gun; and
a monitoring system comprising one or more processors, the monitoring system configured to:
obtain data indicative of a flow rate of the fluid along the flow path;
obtain data indicative of a pressure of the fluid along the flow path;
determine a tip wear metric indicative of a wear of the spray tip based at least on the data indicative of the flow rate of the fluid along the flow path and the data indicative of the pressure of the fluid along the flow path; and
control a display screen to generate a display based on the tip wear metric.

2. The system of claim 1, wherein data indicative of the flow rate of the fluid along the flow path comprises sensor data indicative of a sensed speed of a motor that drives the pump.

3. The system of claim 1, wherein the data indicative of the flow rate of the fluid along the flow path comprises a calculated flow rate metric.

4. The system of claim 1, wherein the data indicative of the pressure of the fluid along the flow path comprises sensor data indicative of a sensed pressure of fluid along the flow path.

5. The system of claim 1, wherein the tip wear metric is indicative of a size of the tip orifice of the spray tip.

6. The system of claim 1, wherein the tip wear metric is indicative of a remaining life of the spray tip.

7. The system of claim 6, wherein the one or more processors are further configured to:
determine a size of the tip orifice of the spray tip;
compare the determined size of the tip orifice of the spray tip to a reference size of the tip orifice of the spray tip; and
determine the tip wear metric, indicative of the remaining life of the spray tip, based on the comparison of the determined size of the tip orifice of the spray tip to the reference size of the tip orifice of the spray tip.

8. The system of claim 6, wherein the display comprises a gauge display element, the gauge display element defining a graphical volume and including a fill element that visually fills at least a portion of the graphical volume to indicate the remaining life of the spray tip.

9. The system of claim 8, wherein the gauge display element is in a shape of a spray tip.

10. The system of claim 1, wherein the one or more processors comprise a plurality of processors, the plurality of processors comprising a first one or more processors coupled to the pump and a second one or more processors remote from the pump.

11. The system of claim 10, wherein the first one or more processors are configured to obtain the data indicative of the flow rate of the fluid along the flow path, obtain the data indicative of a pressure of the fluid along the flow path, and determine a size of the tip orifice of the spray tip based at least on the data indicative of the flow rate of the fluid along the flow path and the data indicative of the pressure of the fluid along the flow path, and
wherein the second one or more processors are remote from the pump and are communicatively coupled to the first one or more processors, and the second one or more processors are configured to determine, as the tip wear metric, a metric indicative of a remaining life of the spray tip based at least on the determined size of the tip orifice of the spray tip.

12. The system of claim 11, wherein the second one or more processors and the display screen are disposed on a mobile device.

13. A computer-implemented method comprising:
obtaining data indicative of a flow rate of fluid pumped along a flow path to a fluid applicator;
obtaining data indicative of a pressure of the fluid pumped along the flow path;
generating a tip wear metric indicative of a wear of a spray tip of the fluid applicator based at least on the data indicative of the flow rate of the fluid pumped along the flow path and the data indicative of the pressure of the fluid pumped along the flow path; and
control a display screen to generate a display based on the tip wear metric.

14. The computer-implemented method of claim 13, wherein obtaining data indicative of the flow rate of the fluid pumped along the flow path comprises obtaining sensor data indicative of a sensed speed of a motor that drives a pump that pumps the fluid along the flow path.

15. The computer-implemented method of claim 13, wherein obtaining data indicative of the flow rate of the fluid pumped along the flow path comprises calculating a flow rate metric based at least on a value indicative of a speed of a motor that drives a pump that pumps the fluid along the flow path.

16. The computer-implemented method of claim 13, wherein obtaining the data indicative of the pressure of the fluid pumped along the flow comprises obtaining sensor data indicative of a sensed pressure of fluid along the flow path.

17. The computer-implemented method of claim 13, wherein generating the tip wear metric comprises determining a size of a tip orifice of the spray tip of the fluid applicator based at least on the data indicative of the flow rate of the fluid pumped along the flow path and the data indicative of the pressure of the fluid pumped along the flow path.

18. The computer-implemented method of claim 17, wherein generating the tip wear metric further comprises comparing the determined size of the tip orifice of the spray tip of the fluid applicator to a reference tip orifice size corresponding to the spray tip of the fluid applicator.

19. The computer-implemented method of claim 18, wherein generating the tip wear metric further comprises generating the tip wear metric being indicative of a remaining life of the spray tip based on the comparison of the determined size of the tip orifice of the spray tip of the fluid applicator to the reference tip orifice size corresponding to the spray tip of the fluid applicator.

20. The computer implemented method of claim 19, wherein controlling the display screen to generate the display based on the tip wear metric comprises controlling the display screen to generate the display including a gauge display element defining a graphical volume and a fill element that fills at least a portion of the graphic volume to indicate the remaining life of the spray tip.

21. A tip wear system comprising:
one or more processors configured to:
obtain data indicative of a flow rate of fluid pumped, by a pump, along a flow path to a fluid applicator;
obtain data indicative of a pressure of the fluid pumped along the flow path;
determine a tip wear metric indicative of a wear of the spray tip based at least on the data indicative of the flow rate of the fluid pumped along the flow path and the data indicative of the pressure of the fluid along the flow path; and
control a display screen to generate a display based on the tip wear metric.

22. The tip wear system of claim 21, wherein the display comprises a gauge display element, the gauge display element defining a graphical volume and including a fill element that fills at least a portion of the graphical volume to indicate the wear of the spray tip.
